(19) United States
(12) Patent Application Publication
(10) Pub. No.: US 2019/0079881 A1
(43) Pub. Date: Mar. 14, 2019

(54) MEMORY ACCESS CONTROL DEVICE, IMAGE PROCESSING DEVICE, AND IMAGING DEVICE

(71) Applicant: OLYMPUS CORPORATION, Tokyo (JP)

(72) Inventors: Keisuke Nakazono, Tokyo (JP); Akira Ueno, Tokyo (JP)

(73) Assignee: OLYMPUS CORPORATION, Tokyo (JP)

(21) Appl. No.: 16/190,799

(22) Filed: Nov. 14, 2018

Related U.S. Application Data
(63) Continuation of application No. PCT/JP2016/067527, filed on Jun. 13, 2016.

(51) Int. Cl. G06F 13/16; G06F 13/362; G06F 13/18

(52) U.S. Cl. CPC G06F 13/1684; G06F 13/18; G06F 13/362

(57) ABSTRACT

The present invention provides a plurality of bus masters configured to output an access request to a memory in which an address space is divided into a plurality of banks, an arbiter configured to arbitrate the access request output from each of the bus masters and control access to the memory in response to the access request which has been accepted, and a request acceptance history acquisition section configured to acquire information about a plurality of access requests accepted by the arbiter and output the stored request acceptance history information. At least one bus master with a high priority is configured to output the access request for specifying the banks in a determined order with reference to the request acceptance history information when the plurality of banks of the memory are successively accessed.

This application is a continuation application based on PCT Patent Application No. PCT/JP 2016/067527, filed Jun. 13, 2016.

### TECHNICAL FIELD

The present invention relates to a memory access control device, an image processing device, and an imaging device.

### BACKGROUND ART

In an imaging device such as a still-image camera, a moving-image camera, a medical endoscope camera, or an industrial endoscope camera, various image processing is performed by an image processing device such as a mounted system LSI. In many system LSIs such as image processing devices mounted on imaging devices, one connected dynamic random access memory (DRAM) is shared by a plurality of built-in processing blocks (hereinafter referred to as “bus masters”). In such system LSIs, each of the plurality of built-in bus masters is connected to a data bus inside the system LSI and each leis master accesses the DRAM according to a direct memory access (DMA) transfer. At this time, each bus master outputs a request for access to the DRAM (a DMA request) and information about the access to the DRAM (access information) such as an address or an access direction (writing or reading).

The system LSI also includes a DMA arbitration circuit (hereinafter referred to as an “arbiter”) for arbitrating a DMA request issued from each of the plurality of built-in bus masters. The arbiter controls actual access to the DRAM while suitably arbitrating the DMA request issued from each bus master. In the arbitration of the DMA request by this arbiter, it is necessary to arbitrate the DMA request from each bus master so as to satisfy the performance of a system (the bus master). Thus, the arbiter basically selects and accepts a DMA request for maximizing the efficiency of access to the DRAM from among DMA requests issued from each of the bus masters.

Meanwhile, a normal DRAM has various restrictions during access. One restriction is that, because a bank accessed once (for example, corresponding to a low-order bit of the address) is in a bank busy state, it is necessary to make a predetermined time (a fixed time) free when the same bank is re-accessed. Also, another restriction is that a fixed reading/writing switching time is required for switching of the access direction of the DRAM, i.e., switching from reading access for reading data stored in the DRAM to writing access for writing and storing, data in the DRAM or vice versa, i.e., switching from the writing access to the reading access. When the DRAM is accessed, the efficiency of access to the DRAM is lowered unless access for avoiding the above-described restrictions is performed.

Thus, the arbiter determines a bus master of which the DMA request is accepted from access information, a priority of each bus master, and a current state of the DRAM (a bank busy state or a reading access state or writing access state) in the DMA request currently issued by each bus master. More specifically, the arbiter prioritizes efficiently accessing the DRAM and determines a bus master which has a high priority and the same access direction (reading or writing) for the DRAM and accesses a bank which is not in the bank busy state as a bus master of which the DMA request is accepted from among the DMA requests issued from the bus masters. Thereby, it is possible to secure a flow of data on the data bus to which the DRAM is connected, i.e., the bus bandwidth, in the system LSI and to guarantee an operation of the entire system of the imaging device equipped with the system LSI.

Meanwhile, in the imaging device, there is a function requiring a real-time property such as photographing of a subject or display of a display image for checking the subject to be photographed, i.e., a so-called live view image (through image). In the imaging device, if a DMA request issued by a bus master for implementing the function requiring a real-time properly is on standby, a system operation of the imaging device may fail. Thus, in the imaging device, the priority of the bus master for implementing the function requiring a real-time property is set to a high priority, and the arbiter preferentially accepts the DMA request issued by a high-priority bus master requiring a real-time property. Also, there is a bus master which successively accesses a plurality of banks among high-priority bus masters provided in the imaging device. In such a bus master, a method called bank interleaving is used to sequentially access different banks, i.e., without successively accessing the same bank.

Thus, when a high-priority bus master issues a DMA request in the imaging device, a considerable amount of time is required until a DMA request issued from another bus master with a lower priority, a DMA request with an opposite direction of access to the DRAM, a DMA request for accessing the same bank, or the like is accepted. However, even when the bus master has a low priority, if a frequency with which the issued DMA request is accepted is significantly lowered, the system operation of the imaging device may fail.

Therefore, for example, technology of a memory control device as in Japanese Unexamined Patent Application, First Publication No. 2010-218323 has been disclosed. In Japanese Unexamined Patent Application First Publication No. 2010-218323, the technology of a memory control device for controlling each access request so that the access request is accepted at least for every fixed period, i.e., an arbiter (a DMA arbitration circuit), by masking a request for access to a bank which is in a busy state and releasing the mask when a predetermined fixed time has elapsed from the issuance of the access request is disclosed. Also, in Japanese Unexamined Patent Application First Publication No. 2010-218323, technology in which a so-called round-robin operation in which the priority of a bus master of which an access request has been accepted is set to a lowest priority is performed and the priority of an access request of the same access direction as that of a currently accepted access request is set to a high priority is disclosed. Thereby, in the memory control device of the technology disclosed in Japanese Unexamined Patent Application, First Publication No. 2010-218323, successive accesses to the same bank can be prevented and the efficiency of access to the DRAM can be improved.

However, in the technology disclosed in Japanese Unexamined Patent Application, First Publication No. 2010-218323, although it is possible to improve the efficiency of access to the DRAM at a point in time when the access request is arbitrated, a bank to be accessed according to an access request for which a mask is released and a bank currently accessed by a high-priority bus master or a bank to be subsequently accessed can be the same bank, i.e., a so-called bank collision can be caused, according to a timing at which the mask is released. This is because, in the technology disclosed in Japanese Unexamined Patent Application, First Publication No. 2010-218323, the issued access request is masked on the basis of access information in the access request issued by each bus master at a point in time when the access request is arbitrated, i.e., a DMA request, and a current bank busy state in the DRAM and therefore each bus master does not consider the order of banks to be accessed for the DRAM.

More specifically, if an access request of a low-priority bus master for accessing the same bank as a bank to be accessed by a high-priority bus master is released after an access request of the high-priority bus master is accepted, the low-priority bus master waits for the released access request to be accepted until a bank busy state according to the access of the high-priority bus master ends regardless of that the mask of the access request is released. Also, if an access request of a low-priority bus master for accessing the same bank as a bank to be accessed by a high-priority bus master is released at a timing close to the end of the bank busy state, the access request released in the low-priority bus master is accepted, but the high-priority bus master waits for the access request to be accepted until the bank busy state according to the access by the low-priority bus master ends. Furthermore, if an order of banks to be accessed by the low-priority bus master for which the mask is released is similar to an order of banks to be accessed by the high-priority bus master, the high-priority bus master waits for the access request to be accepted until the bank busy state ends at all times.

Also, even when an order of banks according to bank interleaving is changed, there is a difference in a frequency but the high-priority bus master similarly waits for the access request to be accepted because the order of banks to be accessed by the bus master is not considered in the technology disclosed in Japanese Unexamined Patent Application, First Publication No. 2010-218323. If such bank collisions frequently occur, the efficiency of access to the DRAM may be lowered and the operation of the system may also fail.

### SUMMARY OF INVENTION

### Solution to Problem

According to a first aspect of the present invention, there is provided a memory access control device, including: a plurality of bus masters configured to output an access request to a memory in which an address space is divided into a plurality of banks; an arbiter connected to the memory and configured to arbitrate the access request output from each of the bus masters and control access to the memory in response to the access request which has been accepted; and a request acceptance history acquisition section configured to acquire information about a plurality of access requests accepted by the arbiter, store the acquired information as request acceptance history information, and output the stored request acceptance history information, wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and output the access request for specifying the banks in the determined order.

According to a second aspect of the present invention, in the memory access control device according to the above-described first aspect, the request acceptance history acquisition section may be configured to store the request acceptance history information including information of the banks specified in the access request and information indicating a direction of access to the memory are associated for each access request accepted by the arbiter, and the high-priority bus master may be configured to determine the order of banks specified according to each access request on the basis of the information of the banks included in the request acceptance history information and avoiding access to the same bank within a predetermined time.

According to a third aspect of the present invention, in the memory access control device according to the above-described second aspect, the request acceptance history acquisition section may further configured to acquire information indicating a timing at which the access request has been accepted by the arbiter, and the request acceptance history information is including the acquired information indicating the timing.

According to a fourth aspect of the present invention, in the memory access control device according to the above-described third aspect, the request acceptance history acquisition section may be configured to store a predetermined number of pieces of the request acceptance history information going back from the access request most recently accepted by the arbiter or the request acceptance history information for a predetermined fixed period from a current point in time into the past.

According to a fifth aspect of the present invention, in the memory access control device according to the above-described fourth aspect, the request acceptance history acquisition section may be configured to set a period for storing the request acceptance history information on the basis of the predetermined time.

According to a sixth aspect of the present invention, in the memory access control device according to the above-described first aspect, the high-priority bus master may configured to output a request acceptance mask signal for issuing an instruction for masking acceptance of the access request input from another bus master during a period until the access request is first output from when a process of determining the order of banks specified according to each access request starts, and the arbiter may configured to mask the access request input from a bus master other than the high-priority bus master in accordance with the request acceptance mask signal.

According to a seventh aspect of the present invention, in the memory access control device according to the above-described sixth aspect, the arbiter may further configured to mask the access request input from another bus master during a period in which each access request is output from the high-priority bus master.

According to an eighth aspect of the present invention, there is provided an image processing device, including: a memory access control device which includes a plurality of bus masters configured to output an access request to a memory in which an address space is divided into a plurality of banks; an arbiter connected to the memory and configured to arbitrate the access request output from each of the bus masters and control access to the memory in response to the access request which has been accepted; and a request acceptance history acquisition section configured to acquire information about a plurality of access requests accepted by the arbiter, store the acquired information as request acceptance history information, and output the stored request acceptance history information, wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and is configured to output the access request for specifying the banks in the determined order.

According to a ninth aspect of the present invention, there is provided an imaging device, including: an image processing device which includes a memory access control device including a plurality of bus masters configured to output an access request to a memory in which an address space is divided into a plurality of banks; an arbiter connected to the memory and configured to arbitrate the access request output from each of the bus masters and control access to the memory in response to the access request which has been accepted; and a request acceptance history acquisition section configured to acquire information about a plurality of access requests accepted by the arbiter, store the acquired information as request acceptance history information, and output the stored request acceptance history information, wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and is configured to output the access request for specifying the banks in the determined order.

### BRIEF DESCRIPTION OF DRAWINGS

FIG. 1 is a block diagram showing a schematic configuration of an imaging device equipped with an image processing device including a memory access control device according to a first embodiment of the present invention.

FIG. 2 is a block diagram showing a schematic configuration of the memory access control device according to the first embodiment of the present invention.

FIG. 3 is a block diagram showing a schematic configuration of a DMA bus arbitration section constituting the memory access control device according to the first embodiment of the present invention.

FIG. 4 is a diagram schematically showing an example of a configuration of a request acceptance history acquisition section provided in the DMA bus arbitration section constituting the memory access control device according to the first embodiment of the present invention.

FIG. 5 is a block diagram showing a schematic configuration of a bus master constituting the memory access control device according to the first embodiment of the present invention.

FIG. 6 is a diagram showing a process of determining an order of addresses in which an address order generation section provided in the bus master constituting the memory access control device according to the first embodiment of the present invention.

FIG. 7 is a timing chart showing an example of an access timing of DRAM by the memory access control device according to the first embodiment of the present invention.

FIG. 8 is a diagram showing another process of determining an order of addresses in which the address order generation section provided in the bus master constituting the memory access control device according to the first embodiment of the present invention.

FIG. 9 is a diagram showing further another process of determining an order of addresses in which the address order generation section provided in the bus master constituting the memory access control device according to the first embodiment of the present invention.

FIG. 10 is a block diagram showing a schematic configuration of a memory access control device according to a second embodiment of the present invention.

FIG. 11 is a block diagram showing a schematic configuration of a high-priority bus master constituting the memory access control device according to the second embodiment of the present invention.

FIG. 12 is a timing chart showing an example of an operation timing of the high-priority bus master constituting the memory access control device according to the second embodiment of the present invention.

### DESCRIPTION OF EMBODIMENTS

### First Embodiment

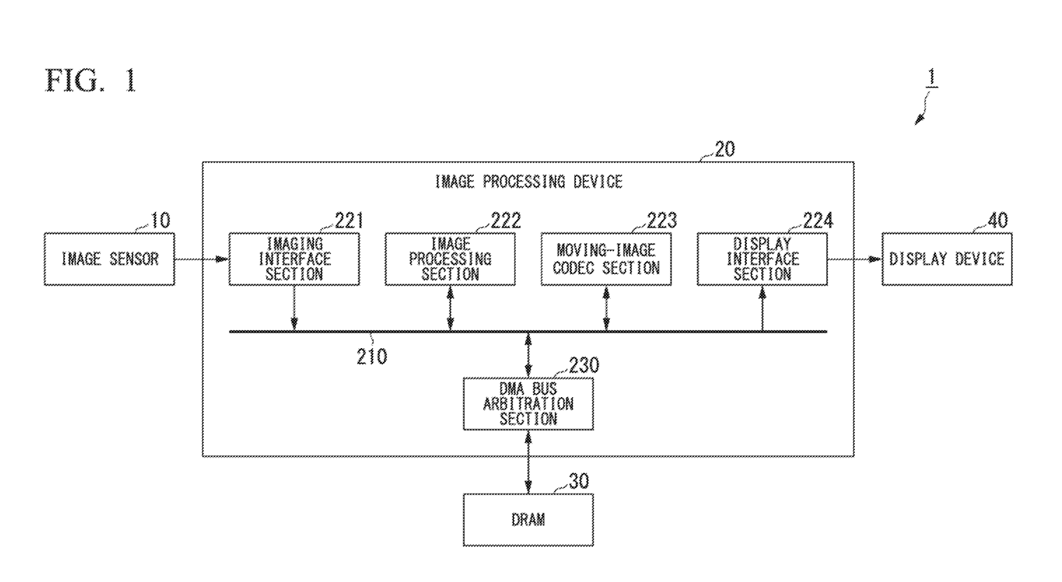

Hereinafter, embodiments of the present invention will be described with reference to the drawings. In the following description, for example, a case in which a memory access control device according to a first embodiment of the present invention is provided in an image processing device mounted on an imaging device such as a still-image camera or a moving-image camera will be described. FIG. 1 is a block diagram showing a schematic configuration of the imaging device equipped with the image processing device including the memory access control device according to the first embodiment of the present invention.

The imaging device 1 shown in FIG. 1 includes an image sensor 10, an image processing device 20, a dynamic random access memory (DRAM) 30, and a display device 40. Also, the image processing device 20 includes an imaging interface section 221, an image processing section 222, a moving-image codec section 223, a display interface section 224, and a direct memory access (DMA) bus arbitration section 230. In the image processing device 20, each of the imaging interface section 221, the image processing section 222, the moving-image codec section 223, the display interface section 224, and the DMA bus arbitration section 230 is connected to a DMA bus 210, which is a common data bus. In the imaging device 1 shown in FIG. 1, a configuration of the imaging interface section 221 or the display interface section 224 and the DMA bus arbitration section 230 corresponds to the memory access control device of the present invention.

The imaging device 1 captures a still image or a moving image of a subject with the image sensor 10. Then, the imaging device 1 causes the display device 40 to display a display image corresponding to the captured still image. To addition, the imaging device 1 causes the display device 40 to display a display image corresponding to the captured moving image. Also, the imaging device 1 can cause a record image according to the captured still- or moving-image to be recorded in a recording medium (not shown).

The image sensor 10 is a solid-state imaging device converted to photoelectrically convert an optical image of a subject formed by a lens (not shown) provided in the imaging device 1. For example, the image sensor 10 is a solid-state imaging device represented by a charge coupled device (CCD) image sensor or a complementary metal oxide semiconductor (CMOS) image sensor. The image sensor 10 outputs a pixel signal according to the optical image of the imaged subject to the imaging interface section 221 provided in the image processing device 20.

The DRAM 30 is a memory (a data storage section) configured to store various data to be processed in the image processing device 20 provided in the imaging device 1. The DRAM 30 is connected to the DMA bus 210 via the DMA bus arbitration section 230 provided in the image processing device 20. The DRAM 30 stores image data of each processing step in the image processing device 20. For example, the DRAM 30 stores pixel data output by the imaging interface section 221 on the basis of the pixel signal output from the image sensor 10. Also, for example, the DRAM 30 stores data such as data of an image (a still image or a display image) generated by the image processing section 222 provided in the image processing device 20 or data of an image (a moving image or a display image) generated by the moving-image codec section 223 provided in the image processing device 20. Also, the DRAM 30 also stores data of a record image generated by the image processing section 222 or the moving-image codec section 223 provided in the image processing device 20.

The display device 40 is a display device configured to display a display image output from the display interface section 224 provided in the image processing device 20. Various display devices having different sizes of display images to be displayed, i.e., a different number of pixels, are used as the display device 40. For example, a small-size display device which operates as a thin film transistor (TFT) liquid crystal display (LCD) for displaying an image of a VGA (640×480) size or a viewfinder mounted on the imaging device 1 and configured to allow checking of a subject to be photographed such as an electronic viewfinder (EVF) is used as the display device 40. Also, for example, a large-size display device having a configuration in which it is capable of being attached to or detached from the imaging device 1 and configured to allow displaying and checking of a display image according to a still image or a moving image such as a high-definition television (HDTV) for displaying images of HD (1920×1080) size or an ultra-high-definition television (UHDTV) for displaying 4K2K (3840×2160) images is also used as the display device 40.

The image processing device 20 generate a still image or a moving image by performing predetermined image processing on the pixel signal output from the image sensor 10. Also, the image processing device 20 generates a display image or a record image according to the generated still or moving image. Then, the image processing device 20 causes the display device 40 to display the generated display image. Also, the image processing device 20 can generate a record image according to the generated still image or moving image and cause the generated record image to be recorded on the recording medium (not shown).

The DMA bus arbitration section 230 is an arbiter configured to arbitrate an access request for the DRAM 30 (a DMA request) according to DMA from each component within the image processing device 20 connected to the DMA bus 210. As a result of arbitrating the DMA request for the DRAM 30 from each component, the DMA bus arbitration section 230 outputs DMA permission for notifying the component of which the DMA request has been accepted that the DMA request has been accepted. Also, the DMA bus arbitration section 230 controls a data transfer between the component of which the DMA request has been accepted (the component notified of the DMA permission) and the DRAM 30 via the DMA bus 210, i.e., a DMA transfer. More specifically, the DMA bus arbitration section 230 controls the transfer (writing) of data output to the DMA bus 210 by the component of which the DMA request has been accepted to the DRAM 30 and the output of data acquired (read) from the DRAM 30 to the component of which the DMA request has been accepted.

Also, the DMA bus arbitration section 230 has a function of storing information about accepted DMA requests as a history. The information of the DMA requests stored as the history by the DMA bus arbitration section 230 (hereinafter referred to as “request acceptance history information”) includes at least information of addresses indicating storage regions of the DRAM 30 to be accessed for each accepted DMA request (more specifically, addresses indicating banks into which an address space of the DRAM 30 is divided (hereinafter referred to as “bank addresses”)) and information indicating an access direction (writing or reading) for the DRAM 30. The DMA bus arbitration section 230 stores a predetermined number of pieces of the request acceptance history information (for example, for ten acceptances from a current point in time into the past) or the request acceptance history information of a predetermined fixed period (for example, a predetermined period from a current point in time into the past). Also, as information from the current point in time into the past included in the request acceptance history information, information indicating a timing at which a DMA request was accepted in the past with respect to the current point in time may be included in addition to the information of the bank addresses and the information indicating the access direction described above. Then, the DMA bus arbitration section 230 outputs the stored request acceptance history information to each component.

The imaging interface section 221 is a processing block configured to store (write) pixel signal data output from the image sensor 10 in the DRAM 30. The imaging interface section 221 is a bus master configured to access the DRAM 30 according to the DMA transfer when the pixel signal data is stored (written) in the DRAM 30. The imaging interface section 221 temporarily saves data of pixel signals (hereinafter referred to as “input image date”) output from the image sensor 10. Then, when the saved input image data is output to the DRAM 30 and stored (written) therein, the imaging interface section 221 first outputs a DMA request, a DMA address for specifying a storage region of the DRAM 30 for storing the input image data, and a DMA writing signal for specifying an access direction (writing access) for the DRAM 30 to the DMA bus arbitration section 230. After the output DMA request is accepted by the DMA bus arbitration section 230, i.e., after a notification of the DMA permission is provided from the DMA bus arbitration section 230, the imaging interface section 221 outputs temporarily saved input image data to the DMA bus arbitration section 230 and outputs the temporarily saved input image data to the DRAM 30 for storing (writing) the temporarily saved input image data.

Also, the imaging interface section 221 may be configured to output data of an image generated by performing predetermined imaging processing on the pixel signal output from the image sensor 10 as input image data to the DRAM 30 via the DMA bus arbitration section 230. In the case of this configuration, the imaging interface section 221 may be configured to perform imaging processing when the temporarily stored input image data is output to the DRAM 30 or may be configured to perform image processing on the pixel signal output from the image sensor 10 and then temporarily save the pixel signal subjected to the image processing. Also, imaging processing to be performed by the imaging interface section 221 on pixel signals output from the image sensor 10 is so-called pre-processing such as defect correction and shading correction. However, in the present invention, the imaging processing performed by the imaging interface section 221 on the pixel signal output from the image sensor 10 is not particularly limited.

Also, the imaging interface section 221 also has a function of changing an order fix outputting DMA requests with reference to the request acceptance history in output from the DMA bus arbitration section 230. More specifically, the imaging interface section 221 has a function of changing a DMA address to be output to the DMA bus arbitration section 230 together with the DMA request to a DMA address for avoiding a bank indicated to be in the bank busy state in the request acceptance history information, i.e., specifying a bank different from a previously accessed bank in a bank busy state. According to this function, if the same bank is accessed, the imaging interface section 221 accesses the DRAM 30 in an order for avoiding a restriction that it is necessary to make a predetermined time (a fixed time) free for access to the DRAM 30 and performs a DMA transfer for storing (writing) input image data.

The image processing section 222 is a processing block configured to acquire (read) the input image data stored in the DRAM 30 and cause data of a still image (hereinafter referred to as still-image data) obtained by performing predetermined image processing on the acquired input image data to be stored (written) in the DRAM 30. The image processing section 222 is a bus master configured to access the DRAM 30 according to the DMA transfer when input image data is acquired (read) from the DRAM 30 and when the still-image data is stored (written) in the DRAM 30. When the input image data is acquired (read) from the DRAM 30, the image processing section 222 first outputs a DMA request, a DMA address for specifying a storage region of the DRAM 30 from which the input image data is acquired, and a DMA reading signal for specifying an access direction (reading access) for the DRAM 30 to the DMA bus arbitration section 230. Then, after the output DMA request is accepted by the DMA bus arbitration section 230, the image processing section 222 temporarily stores the input image data read and output from the DRAM 30 by the DMA bus arbitration section 230. Also, when the still-image data generated by performing predetermined image processing on the saved input image data is output to the DRAM 30 for storing (writing) the output image data, the image processing section 222 first outputs a DMA request, a DMA address for specifying a storage region of the DRAM 30 in which the still-image data is stored, and a DMA writing signal for specifying an access direction (writing access) for the DRAM 30 to the DMA bus arbitration section 230. Then, after the output DMA request is accepted by the DMA bus arbitration section 230, the image processing section 222 outputs the still-image data to the DMA bus arbitration section 230 and outputs the still-image data to the DRAM 30 for storing (writing) the still-image data.

Also, when the still-image data is output to the DRAM 30, the image processing section 222 may be configured to perform image processing on the temporarily stored input image data or may be configured to generate still-image data and temporarily save the generated still-image data by performing image processing on the input image data output from the DMA bus arbitration section 230. The image processing to be performed by the image processing section 222 on the input image data is image processing for various types of image processing for display and image processing for recording on a still image such as a noise removal process, a YC conversion process, a resizing process, and a JPEG compression and decompression process. However, in the present invention, the image processing to be performed on the input image data by the image processing section 222 is not particularly limited.

Also, similar to the imaging interface section 221, the image processing section 222 has a function of changing the DMA address to be output to the DMA bus arbitration section 230 together with the DMA request to a DMA address for specifying a bank different from a previously accessed bank in the bank busy state with reference to request acceptance history information output from the DMA bus arbitration section 230. According to this function, similar to the imaging interface section 221, the image processing section 222 also performs the DMA transfer of the acquisition (reading) of the input image data and the storage (writing) of the still-image data by accessing the DRAM 30 in an order for avoiding access restrictions in the DRAM 30.

The moving-image codec section 223 is a processing block configured to acquire (read) input image data stored in the DRAM 30 and cause the DRAM 30 to store (write) data of a moving image (hereinafter referred to as “moving-image data”) generated by performing predetermined image processing on the acquired input image data. The moving-image codec section 223 is a bus master configured to access the DRAM 30 according to the DMA transfer when input image data is acquired (read) from the DRAM 30 and when the moving-image data is stored (written) in the DRAM 30. When the input image data is acquired (read) from the DRAM 30, the moving-image codec section 223 first outputs a DMA request, a DMA address for specifying a storage region of the DRAM 30 from which the input image data is acquired, and a DMA reading signal for specifying an access direction (reading access) for the DRAM 30 to the DMA bus arbitration section 230. Then, after the output DMA request is accepted by the DMA bus arbitration section 230, the moving-image codec section 223 temporarily saves the input image data read and output from the DRAM 30 by the DMA bus arbitration section 230. Also, when the moving-image data generated by performing predetermined image processing on the saved input image data is output to and stored (written) in the DRAM 30, the moving-image codec section 223 first outputs a DMA request, a DMA address for specifying a storage region of the DRAM 30 in which the moving-image data is stored, and a DMA writing signal for specifying an access direction (writing access) for the DRAM 30 to the DMA bus arbitration section 230. Then, after the output DMA request is accepted by the DMA bus arbitration section 230, the moving-image codec section 223 outputs the moving-image data to the DMA bus arbitration section 230 and outputs the moving-image data to the DRAM 30 for storing (writing) the moving-image data.

The moving-image codec section 223 may be configured to perform image processing on temporarily stored input image data when the moving-image data is output to the DRAM 30 or may be configured to generate moving-image data by performing image processing on input image data output from the DMA bus arbitration section 230 and temporarily save the generated moving-image data. The image processing to he performed on the input image data by the moving-image codec section 223 is various types of image processing for display and image processing for recording on a moving image such as an MPEG compression/decompression process and an H.264 compression/decompression process. However, in the present invention, the image processing to be performed on the input image data by the moving-image codec section 223 is not particularly limited.

Also, similar to the imaging interface section 221 and the image processing section 222, the moving-image codec section 223 has a function of changing the DMA address to be output to the DMA bus arbitration section 230 together with the DMA request to a DMA address for specifying a bank different from a previously accessed bank in the bank busy state with reference to request acceptance history information output from the DMA bus arbitration section 230. According to this function, similar to the image processing section 222, the moving-image codec section 223 also performs the DMA transfer of the acquisition (reading) of the input image data and the storage (writing) of the still-image data by accessing the DRAM 30 in an order for avoiding access restrictions in the DRAM 30.

The display interface section 224 is a processing block configured to acquire (read) still-image data and moving-image data stored in the DRAM 30 and cause the display device 40 to display a display image corresponding to the acquired image data. The display interface section 224 is a bus master configured to access the DRAM 30 according to the DMA transfer when still-image data or moving-image data is acquired (read) from the DRAM 30. When the image data is acquired (read) from the DRAM 30, the display interface section 224 first outputs a DMA request, a DMA address for specifying a storage region of the DRAM 30 from which the still-image data or the moving-image data is acquired, and a DMA reading signal for specifying an access direction (reading access) for the DRAM 30 to the DMA bus arbitration section 230. Then, after the output DMA request is accepted by the DMA bus arbitration section 230, the display interface section 224 temporarily saves the image data read and output from the DRAM 30 by the DMA bus arbitration section 230. Then, the display interface section 224 outputs a display image according to the saved image data to the display device 40 for displaying the display image.

Also, the display interface section 224 may be configured to output a display image generated by performing a predetermined display process on the image data output from the DMA bus arbitration section 230 to the display device 40. In the case of this configuration, the display interface section 224 may be configured to perform a display process when temporarily saved image data is output to the display device 40, or may be configured to perform a display process on image data output from the DMA bus arbitration section 230 and then temporarily save the image data subjected to the display process. Also, a display process to be performed on the pixel signal output from the DMA bus arbitration section 230 by the display interface section 224 is, for example, a process of superimposing an on-screen display (OSD) image for displaying various information related to a still image or a moving image such as a photographing date and time or the like. However, in the present invention, the display process to be performed on the pixel signal output from the DMA bus arbitration section 230 by the display interface section 224 is not particularly limited.

Also, similar to the imaging interface section 221, the image processing section 222, and the moving-image codec section 223, the display interface section 224 also has a function of changing the DMA address to be output to the DMA bus arbitration section 230 together with the DMA request to a DMA address for specifying a bank different from a previously accessed bank in the bank busy state with reference to request acceptance history information output from the DMA bus arbitration section 230. According to this function, similar to the imaging interface section 221, the display interface section 224 also performs the DMA transfer for acquiring (reading) the still-image data or the moving-image data by accessing the DRAM 30 in an order for avoiding access restrictions in the DRAM 30.

According to such a configuration, the imaging device 1 captures a still image or a moving image of a subject with the image sensor 10 and causes the display device 40 to display a display image according to a captured still image or moving image. Also, the imaging device 1 can cause a record image according to the still image or the moving image captured by the image sensor 10 to be recorded in the recording medium (not shown).

In the imaging device 1, the memory access control device according to the first embodiment of the present invention includes a bus master which is each processing block provided in the image processing device 20 and the DMA bus arbitration section 230 which is an arbiter. More specifically, in the imaging device 1, an operation of the memory access control device according to the first embodiment of the present invention is implemented according to a function of the arbiter for storing a history (request acceptance history in related to the accepted DMA requests and a function of the bus master for changing an order in which the DMA requests are output with reference to the request acceptance history information. More specifically, in the imaging device 1, the memory access control device according to the first embodiment of the present invention is configured according to a combination of a bus master of which a priority is highest (hereinafter referred to as a “high-priority bus master”) for preferentially performing a DMA transfer and the arbiter.

Also, in the imaging device 1, the bus master serving as the high-priority bus master differs according to an operation to be performed by the imaging device 1, i.e., a so-called operation mode. Thus, in the imaging device 1, the combination of the bus master and the arbiter constituting the memory access control device according to the first embodiment of the present invention differs according to each operation mode.

For example, if the imaging device 1 performs a high-speed continuous photographing operation of successively capturing a plurality of still images at a high speed, the imaging interface section 221 serves as a bus master required to cause the DRAM 30 to sequentially store (write) input image data of each frame output from the image sensor 10 according to the DMA transfer. In this case, the imaging interface section 221 serves as a high-priority bus master configured to preferentially perform the DMA transfer and the memory access control device of the first embodiment of the present invention is configured according to a combination of the imaging interface section 221 and the DMA bus arbitration section 230. Also, for example, when the imaging device 1 captures a still image or a moving image, if a display operation of causing an EVF and a UHDTV to simultaneously display a display image for checking a subject to be photographed, i.e., a so-called live view image (through image), is performed, the display interface section 224 serves as a bus master required to sequentially acquire (read) display image data of each frame stored in the DRAM 30 from the DRAM 30 according to the DMA transfer. In this case, the display interface section 224 serves as a high-priority bus master configured to preferentially perform the DMA transfer and the memory access control device of the first embodiment of the present invention includes the combination of the display interface section 224 and the DMA bus arbitration section 230.

In this manner, in the imaging device 1, in accordance with the operation mode, the memory access control device of the first embodiment of the present invention includes a combination of any bus master (processing block) provided in the image processing device 20 and the arbiter (the DMA bus arbitration section 230).

Also, in the imaging device 1, the number of bus masters (processing blocks) serving as a high-priority bus master in each operation mode is not limited to one. Accordingly, the memory access control device according to the first embodiment of the present invention is not limited to a configuration including one bus master (processing block) and an arbiter (DMA bus arbitration section 230) and may include a plurality of bus masters and an arbiter. For example, if the imaging device 1 performs a moving-image recording operation of causing a moving image of a photographed subject to be recorded in the recording medium (not shown) in real time, the imaging interface section 221, the moving-image codec section 223, and the recording processing section (not shown) serve as bus masters required to sequentially perform the DMA transfers. In this case, each of the imaging interface section 221, the moving-image codec section 223, and the recording processing section (not shown) serves as the high-priority bus master and the memory access control device according to the first embodiment of the present invention includes a combination of a plurality of high-priority bus masters and the DMA bus arbitration section 230.

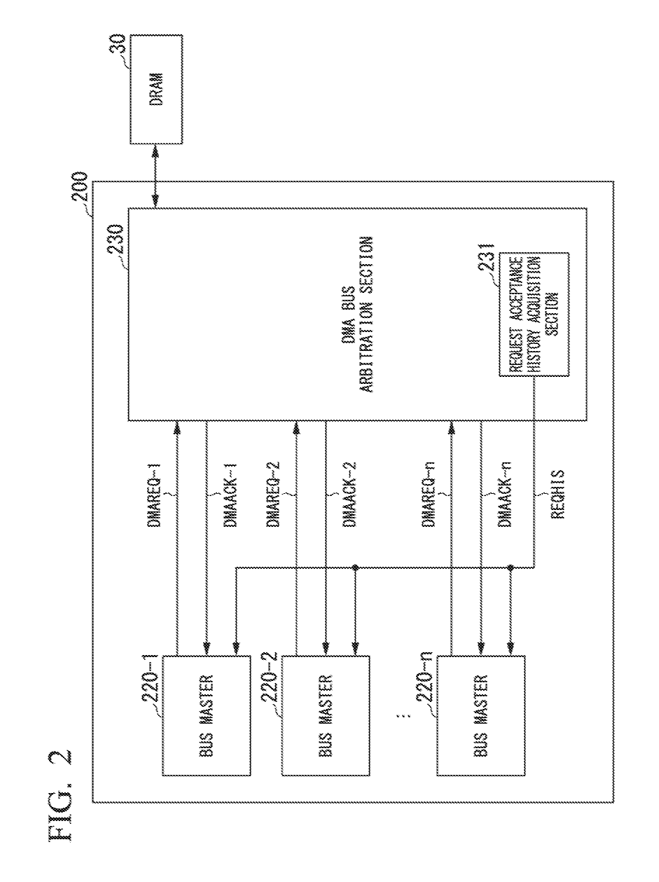

Next, a configuration and an operation of the memory access control device according to the first embodiment of the present invention will be described. FIG. 2 is a block diagram showing a schematic configuration of the memory access control device according to the first embodiment of the present invention. In the following description, the memory access control device according to the first embodiment of the present invention will be referred to as a “memory access control device 200”. In FIG. 2, an example of a schematic configuration of the memory access control device 200 including n (n is a natural number or a positive integer) bus masters (bus masters 220-1 to 220-n) and a DMA bus arbitration section 230 and configured to access the DRAM 30 is shown. In the following description, each of the bus masters 220-1 to 220-n is referred to as a “bus master 220” unless they are distinguished from each other. Also, in the imaging device 1, each of the bus masters 220 corresponds to any one processing block provided in the image processing device 20.

When the DMA transfer starts, each bus master 220 outputs a DMA request signal DMAREQ indicating a request for accessing the DRAM 30 (a DMA request), a DMA address DMAAD indicating an address of the DRAM 30 to be accessed, and a DMA reading/writing signal DMARW for specifying a direction of access to the DRAM 30 to the DMA bus arbitration section 230.

Also, in FIG. 2, only the DMA request signal DMAREQ output by each bus master 220 as a DMA request to the DMA bus arbitration section 230 is shown. In FIG. 2, a numeral for distinguishing the bus master 220 which outputs the DMA request signal DMAREQ is shown after “-” following a signal name of each DMA request signal DMAREQ. More specifically, the DMA request signal DMAREQ output by the bus master 220-1 is denoted as a “DMA request signal DMAREQ-1” in which “1” is shown after “-” following the signal name. Also, the DMA request signal DMAREQ output by the bus master 220-2 is denoted as a “DMA request signal DMAREQ-2” in which “2” is shown after “-” following the signal name. Also, the DMA request signal DMAREQ output from the bus master 220-n is denoted as a “DMA request signal DMAREQ-n” in which “n” is shown after “-” following the signal name.

Also, in the following description, a numeral for distinguishing the bus master 220 is shown after “-” following the signal name in each of the DMA address DMAAD and the DMA reading/writing signal DMARW to be output by each bus master 220 to the DMA bus arbitration section 230 together with the DMA request signal DMAREQ, as in the DMA request signal DMAREQ.

Also, in addition to the DMA request signal DMAREQ, the DMA address DMAAD, and the DMA reading/writing signal DMARW, for example, each bus master 220 may output an amount of data to be transferred from and to the DRAM 30 in the DMA transfer such as a burst length and information such as a current urgency to the DMA bus arbitration section 230 together with the DMA request signal DMAREQ.

The DMA bus arbitration section 230 arbitrates the DMA requests output from the bus masters 220 and outputs the DMA permission to the bus master 220 for which the access to the DRAM 30 has been accepted in response to the DMA request.

Also, in FIG. 2, a DMA permission signal DMAACK for providing a DMA permission notification to each bus master 220 in the DMA bus arbitration section 230 is shown. In FIG. 2, a numeral for distinguishing the bus master 220 from which the DMA permission signal DMAACK is output is shown after “-” following the signal name of each DMA permission signal DMAACK. More specifically, the DMA permission signal DMAACK to be output to the bus master 220-1 is denoted as a “DMA permission signal DMAACK-1” in which “1” is shown after “-” following the signal name. Also, the DMA permission signal DMAACK to be output to the bus master 220-2 is denoted as a “DMA permission signal DMAACK-2” in which “2” is shown after “-” following the signal name. Also, the DMA permission signal DMAACK to be output to the bus master 220-n is denoted as a “DMA permission signal DMAACK-n” in which “n” is shown after “-” following the signal name.

Also, the DMA bus arbitration section 230 outputs request acceptance history information about the accepted DMA request to each bus master 220. In FIG. 2, the DMA bus arbitration section 230, having the request acceptance history acquisition section 231 configured to acquire various information related to the accepted DMA requests and output the acquired information as request acceptance history information REQHIS to each bus master 220 is shown.

After a notification of the DMA permission is provided from the DMA bus arbitration section 230, only the bus master 220 to which the DMA permission signal DMAACK is input from the DMA bus arbitration section 230 starts the requested DMA transfer (access to the DRAM 30). Thereby, the DMA bus arbitration section 230 actually controls the DRAM 30 in accordance with access from the bus master 220 of which the DMA request has been accepted to the DRAM 30. That is, the DMA bus arbitration section 230 performs a data transfer (a DMA transfer) between the bus master 220 of which the DMA request has been accepted and the DRAM 30.

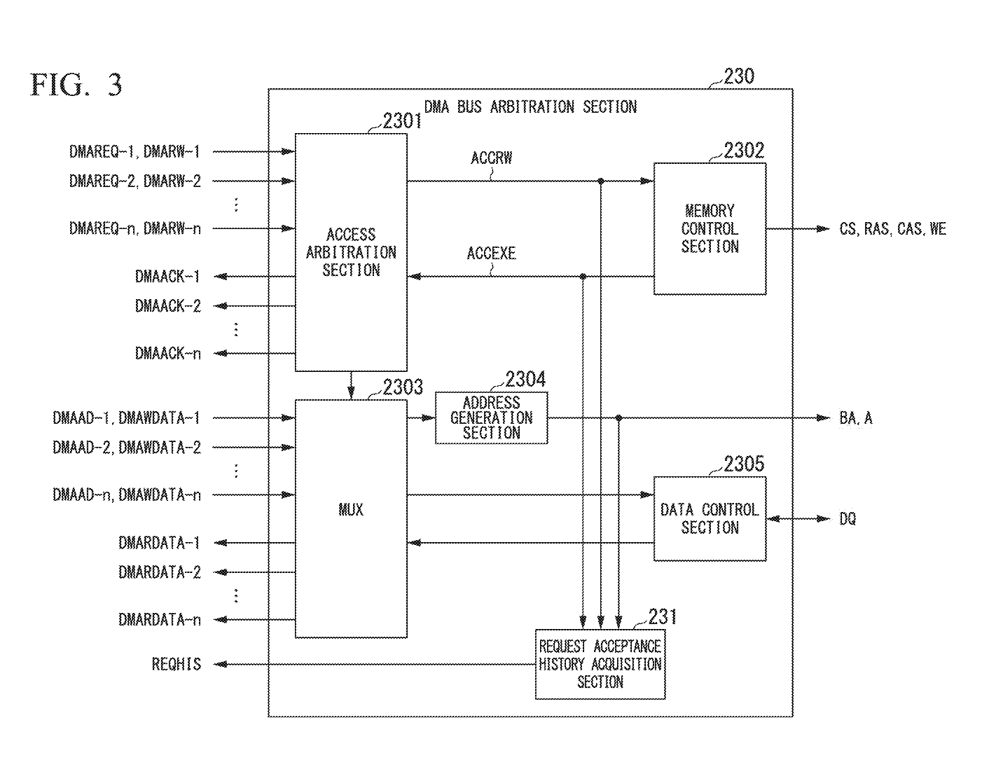

Next, a more detailed configuration and operation of the DMA bus arbitration section 230 constituting the memory access control device 200 will be described. FIG. 3 is a block diagram showing a schematic configuration of the DMA bus arbitration section 230 constituting the memory access control device 200 according to the first embodiment of the present invention. The DMA bus arbitration section 230 includes an access arbitration section 2301, a memory control section 2302, a multiplexer (MUX) 2303, an address generation section 2304, a data control section 2305, and a request acceptance history acquisition section 231.

The access arbitration section 2301 arbitrates the DMA request signal DMAREQ output from each bus master 220 and selects any one bus master 220 from among the bus masters 220 configured to output the DMA request signal DMAREQ. More specifically, the access arbitration section 2301 arbitrates the DMA request signal DMAREQ output from each bus master 220 and sequentially selects the bus masters 220 to maximize the efficiency of access to the DRAM 30 on the basis of a priority of each bus master 220, an urgency according to a length of time during which the output DMA request signal DMAREQ is not accepted, or the like. Also, as a method of selecting (arbitrating) the bus master 220 in the access arbitration section 2301, various selection (arbitration) methods in an existing DMA arbitration circuit (bus arbiter) can be adopted.

Then, the access arbitration section 2301 outputs a selection signal indicating the selected bus master 220 to the multiplexer 2303. Also, the access arbitration section 2301 outputs an access direction signal ACCRW indicating the access direction of the selected bus master 220 for the DRAM 30 to the memory control section 2302. More specifically, the access arbitration section 2301 outputs the access direction signal ACCRW indicating whether the access of the selected bus master 220 to the DRAM 30 is writing access (data writing) or reading access (data reading) to each of the memory control section 2302 and the request acceptance history acquisition section 231 on the basis of the DMA reading/writing signal DMARW output together with the DMA request signal DMAREQ from the selected bus master 220.

Also, the access arbitration section 2301 generates the DMA permission signal DMAACK on the basis of an access execution signal ACCEXE output from the memory control section 2302 when the DRAM 30 is actually controlled in accordance with the output access direction signal ACCRW, and outputs the generated DMA permission signal DMAACK to the selected bus master 220.

In FIG. 3, DMA request signals DMAREQ-1 to DMAREQ-n and DMA reading/writing signals DMARW-1 to DMARW-n to be output to the access arbitration section 2301 by the bus masters 220-1 to 220-n are shown. Also, in FIG. 3, DMA permission signals DMAACK-1 to DMAACK-n to be output to the bus masters 220-1 to 220-n by the access arbitration section 2301 are shown.

On the basis of the access direction signal ACCRW output from the access arbitration section 2301, the memory control section 2302 generates a control signal for actually accessing the DRAM 30 in accordance with access from the bus master 220 selected by the access arbitration section 2301 and outputs the generated control signal to the DRAM 30.

In FIG. 3, a chip select signal CS, a row address strobe signal RAS, a column address strobe signal CAS, and a write enable signal WE to be output to the DRAM 30 by the memory control section 2302 are shown.

Also, the memory control section 2302 generates the access execution signal ACCEXE indicating that the access to the DRAM 30 has actually been performed and outputs the generated access execution signal ACCEXE to each of the access arbitration section 2301 and the request acceptance history acquisition section 231.

The multiplexer 2303 selects the DMA address DMAAD output together with the DMA request signal DMAREQ from the bus master 220 selected by the access arbitration section 2301 in accordance with the selection signal output from the access arbitration section 2301 and outputs the selected DMA address DMAAD to the address generation section 2304. Also, in accordance with the selection signal output from the access arbitration section 2301, the multiplexer 2303 selects DMA writing data DMAWDATA output together with the DMA request signal DMAREQ when the bus master 220 selected by the access arbitration section 2301 perform writing access to the DRAM 30 and outputs the selected DMA writing data DMAWDATA to the data control section 2305.

Also, in accordance with the selection signal output from the access arbitration section 2301, the multiplexer 2303 outputs data actually read and output from the DRAM 30 by the data control section 2305 when the bus master 220 selected by the access arbitration section 2301 has performed reading access to the DRAM 30 as DMA reading data DMARDATA to the bus master 220 selected by the access arbitration section 2301.

In FIG. 3, DMA addresses DMAAD-1 to DMAAD-n and DMA writing data DMAWDATA-1 to DMAWDATA-n output from the bus masters 220-1 to 220-n to the multiplexer 2303 are shown. Also, in FIG. 3, DMA reading data DMARDATA-1 to DMARDATA-n output to the bus masters 220-1 to 220-n by the multiplexer 2303 is shown.

On the basis of the DMA address DMAAD output from the multiplexer 2303, the address generation section 2304 generates the address of the DRAM 30 to be actually accessed in accordance with access from the bus master 220 selected by the access arbitration section 2301 and outputs the generated address to the DRAM 30.

In FIG. 3, a bank address BA and a matrix address A output to the DRAM 30 and the request acceptance history acquisition section 231 by the address generation section 2304 are shown. Also, the address generation section 2304 also outputs the generated bank address BA to the request acceptance history acquisition section 231.

When the bus master 220 selected by the access arbitration section 2301 performs writing access to the DRAM 30, the data control section 2305 outputs the DMA writing data DMAWDATA output from the multiplexer 2303 as data to actually be written (stored) to the DRAM 30. Also, when the bus master 220 selected by the access arbitration section 2301 performs reading access to the DRAM 30, the data control section 2305 outputs the data actually read (acquired) from the DRAM 30 to the multiplexer 2303.

In FIG. 3, data (DQ) to be transferred (read/written) by the data control section 2305 to/from the DRAM 30, i.e., data (DQ) to be subjected to the DMA transfer of the bus master 220 selected by the access arbitration section 2301 from/to the DRAM 30, is shown.

On the basis of the access execution signal ACCEXE output from the memory control section 2302, the access direction signal ACCRW output from the access arbitration section 2301, and the bank address BA output from the address generation section 2304, the request acceptance history acquisition section 231 acquires information related to the DMA request of the bus master 220 selected by the access arbitration section 2301 (request acceptance history information). As described above, at least information of the bank address BA of the DRAM 30 to be accessed in the accepted DMA request and information indicating the direction of access to the DRAM 30 are included as the request acceptance history information. The request acceptance history acquisition section 231 stores the information of the bank address BA and the information indicating the access direction in association. Also, if the request acceptance history information further includes information such as information indicating a timing at which the DMA request has been accepted, the information of the bank address BA, the information indicating the access direction, and the information indicating the timing at which the DMA request has been accepted are stored in association. Then, the request acceptance history acquisition section 231 outputs the stored information as the request acceptance history information REQHIS to the bus masters 220.

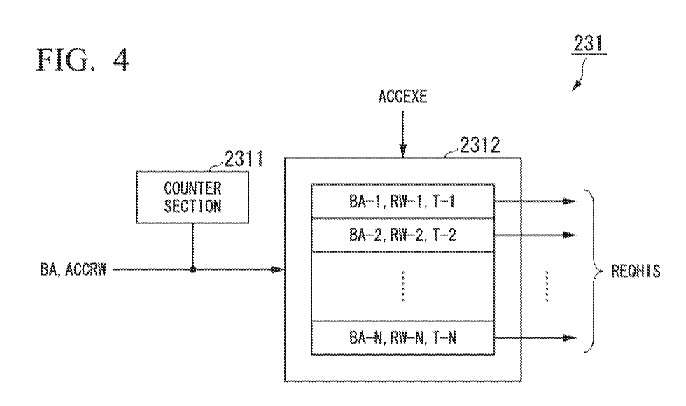

Here, a configuration in which the request acceptance history acquisition section 231 acquires and stores the request acceptance history information will be described. FIG. 4 is a diagram schematically showing an example of the configuration of the request acceptance history acquisition section 231 provided in the DMA bus arbitration section 230 constituting the memory access control device 200 according to the first embodiment of the present invention. In FIG. 4, the configuration of the request acceptance history acquisition section 231 configured to acquire information indicating a timing at which the DMA request has been accepted as the request acceptance history information in addition to the information of the bank address BA and the information indicating the access direction is shown. The request acceptance history acquisition section 231 includes a counter section 2311 and a request acceptance history storage section 2312.

The counter section 2311 is a time measurement section configured to measure an elapsed time from when the DMA bus arbitration section 230 starts an operation on the basis of a clock signal by which the DRAM 30 operates. The counter section 2311 sequentially outputs information of the measured elapsed time (hereinafter referred to as a “time T”) to the request acceptance history storage section 2312.

Also, the counter section 2311 may be configured to periodically measure a predetermined period (time) from when the DMA bus arbitration section 230 has started an operation. In the case of this configuration, because the time T indicated by the counter section 2311 is repeated in a cycle of a predetermined period (time), a chronological order indicated by the time T may be reversed if two times are times of different cycles when the two times are compared. However, if a predetermined period (time) periodically measured by the counter section 2311 is known, it is possible to correctly determine the chronological order between the two times. For example, because the counter section 2311 periodically and successively measures the bank busy time by setting a predetermined period (time) periodically measured by the counter section 2311 to a predetermined time required to be free when the same bank of the DRAM 30 is accessed, i.e., a bank busy time in which the DRAM 30 is in the bank busy state, it is possible to correctly determine the chronological order of two times within the bank busy time.

In the following description, for ease of description, an example in which the counter section 2311 has a configuration of a free run counter configured to measure an elapsed time from when the DMA bus arbitration section 230 has started an operation will be described. Accordingly, the counter section 2311 sequentially outputs times T in which the chronological order of times is not reversed to the request acceptance history storage section 2312.

The request acceptance history storage section 2312 is a data storage section configured to store the information of the bank address BA output from the address generation section 2304, the access direction signal ACCRW output from the access arbitration section 2301, and the time T output from the counter section 2311 in association as request acceptance history information at a timing when the access execution signal ACCEXE has been input from the memory control section 2302. The request acceptance history storage section 2312 includes a memory having, for example, a first in, first out (FIFO) type memory including a plurality of storage regions for storing associated information.

Every time the access execution signal ACCEXE is input from the memory control section 2302, the request acceptance history storage section 2312 stores the information of the bank address BA, the information of the access direction (reading access or writing access) indicated by the access direction signal ACCRW, and the information of the time T (i.e., information of a time at which the access execution signal ACCEXE has been input) in the storage region in association. Then, the request acceptance history storage section 2312 outputs information stored in association with each storage region as the request acceptance history information REQHIS to each bus master 220.

In FIG. 4, an example of the request acceptance history, storage section 2312 configured as an FIFO type including an N-stage is a natural number or a positive integer) storage region and configured to store information of each of the bank address BA, the access direction RW, and the time T for each storage region in association is shown. Also, in FIG. 4, a numeral indicating a number of the storage region after “-” following information is shown. More specifically, when “1” is shown after “-” following information stored in a first storage region provided in the request acceptance history storage section 2312, a “bank address BA-1”, an “access direction RW-1” and a “time T-1” are represented. Also, when “2” is shown after “-” following information stored in a second storage region provided in the request acceptance history storage section 2312, a “bank address BA-2”, an “access direction RW-2” and a “time T-2” are represented. Also, when “N” is shown after “-” following information stored in an N^{th} storage region provided in the request acceptance history storage section 2312, a “bank address BA-N”, an “access direction RW-N” and a “time T-N” are represented.

Also, the request acceptance history storage section 2312 may be configured to include a number of storage regions capable of storing at least request acceptance history information of a period set on the basis of the bank busy time in the DRAM 30 (for example, a period which is the same as a bank busy time). In this configuration, it is possible to reduce a storage region provided in the request acceptance history storage section 2312, i.e., a storage capacity of the FIFO type memory. The request acceptance history storage section 2312 of this configuration is operated to discard the request acceptance history information after the bank busy time elapses, i.e., information of the past in which each bank of the DRAM 30 was accessed, by overwriting the information with latest information. Even in this operation, the request acceptance history acquisition section 231 can implement a function similar to that of a configuration having more storage regions. This is because the bank busy time in the DRAM 30 is predetermined according to a standard of the DRAM 30 and the request acceptance history information accessed before the bank busy time for each bank of the DRAM 30 is information which is not required to be used when a bank address to be accessed for allowing the bus master 220 to be described below to avoid a bank collision is determined.

Also, the configuration of the request acceptance history storage section 2312 is not limited to a FIFO type configuration described above. For example, the request acceptance history storage section 2312 may be configured to include at least storage regions corresponding to banks provided in the DRAM 30, i.e., storage regions equal in number to banks provided in the DRAM 30. In the request acceptance history storage section 2312 of this configuration, every time each bank is accessed, an operation is performed so that information of each of the access direction R and the time T stored in the storage region corresponding to the accessed bank is updated.

Also, in the following description, an example in which the configuration of the request acceptance history storage section 2312 is the above-described FIFO type configuration will be described. Then, an example in which, every time information of the bank address BA, the access direction RW, and the time T is newly acquired in the request acceptance history acquisition section 231, information previously stored in each storage region is sequentially moved to a storage region obtained by adding (incrementing) the number of the storage region shown after “-” following the information by “1” in the request acceptance history storage section 2317 will be described. That is, in the following description, latest information is denoted by a reference sign in which “1” is shown after “-” at all times. Also, in the following description, when information of each of the bank address BA, the access direction RW, and the time T included in the request acceptance history information is represented distinction, a numeral indicating the number of the storage region storing the request acceptance history information is shown after “-” following the request acceptance history information REQHIS.

Next, a more detailed configuration and operation of the bus master 220 constituting the memory access control device 200 will be described. Also, in the following description, the bus master 220 in which the direction of access to the DRAM 30 in the DMA transfer is only writing access (data writing) will be described as an example. The bus master 220 configured to perform the DMA transfer only for the writing access corresponds to, for example, the imaging interface section 221 in the imaging device 1 shown in FIG. 1.

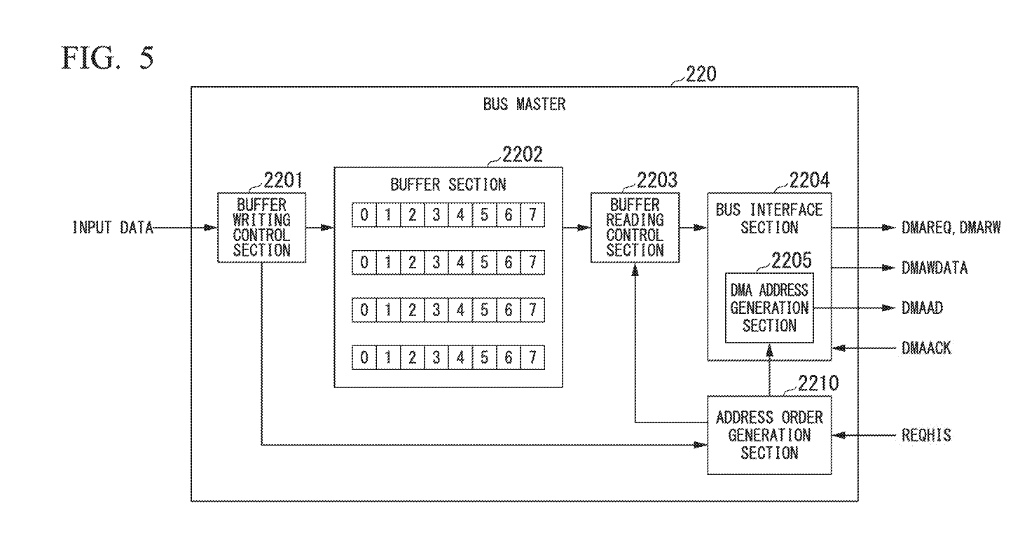

FIG. 5 is a block diagram showing a schematic configuration of the bus master 220 constituting the memory access control device 200 according to the first embodiment of the present invention. In FIG. 5, an example of a configuration of the bus master 220 for collectively transferring data for eight banks in the DMA transfer according to a successive transfer for successively accessing eight banks, i.e., successively performing eight DMA transfers, with respect to the DRAM 30 having an address space which is divided into eight banks is shown. Here, the successive transfer indicates that eight requests are successively issued unlike a burst transfer function inherently provided in a general DRAM. That is, the successive transfer represents that eight DMA transfers are successively performed when a state in which the bus master 220 successively performs the eight DMA transfers is reached. Thus, in each of the eight DMA transfers which are successively performed in the successive transfer, a different bank address BA is accessed.

The bus master 220 includes a buffer writing control section 2201, a buffer section 2202, a buffer reading control section 2203, a bus interface section 2204, and an address order generation section 2210. Also, the bus interface section 2204 includes a DMA address generation section 2205.

The buffer writing control section 2201 sequentially outputs and stores (saves) input data which has been input (for example, pixel signal data output from the image sensor 10) to the buffer section 2202.

The buffer section 2202 is a data storage section configured to temporarily store (save) the input data sequentially output from the buffer writing control section 2201. For example, the buffer section 2202 includes a memory such as a static random access memory (SRAM). The buffer section 2202 includes at least storage regions equal in number to banks provided in the DRAM 30, wherein the storage region saves data to be transferred to the DRAM 30 according to the DMA transfer. Thus, the buffer section 2202 provided in the bus master 220 shown in FIG. 5 configured to collectively transfer data for eight banks provided in the DRAM 30 according to a DMA transfer (a successive transfer) has at least eight storage regions. In FIG. 5, numerals indicating corresponding banks of the DRAM 30 are shown in the storage regions within the buffer section 2202. In the bus master 220, all data stored in one set of storage regions provided in the buffer section 2202 is a transfer unit of a successive transfer and data in each storage region is a transfer unit for one DMA transfer.

Also, in FIG. 5, the buffer section 2202 configured to include four sets, each of which includes eight storage regions corresponding to eight banks provided in the DRAM 30 is shown. According to this configuration, the bus master 220 can perform four successive transfers for successively transferring data for the sets of storage regions.

When input data is stored (saved) in any set of storage regions in the buffer section 2202 by the buffer writing control section 2201, the buffer reading control section 2203 sequentially reads the stored (saved) input data for each storage region corresponding to each bank in accordance with information indicating an order of addresses ((hereinafter referred to as “address order information”) output from the address order generation section 2210 when the DMA transfer is performed. Then, the buffer reading control section 2203 sequentially outputs the read input data to the bus interface section 2204. That is, the buffer reading control section 2203 sequentially reads all input data of a transfer unit of one successive transfer stored (saved) in the buffer section 2202 for each transfer unit of the DMA transfer in an order indicated by address order information and transfers the read data to the bus interface section 2204.

Also, a timing at which the buffer writing control section 2201 stores (saves) the input data in the buffer section 2202 and a timing at which the buffer reading control section 2203 reads the input data stored (saved) in the buffer section 2202 in the bus master 220 are not limited at all. Accordingly, the buffer section 2202 may be an SRAM capable of controlling an input data writing timing and an input data reading timing such that they are different timings. Also, a configuration or a method by which a timing at which the storage (storage) of input data of one transfer unit in the buffer section 2202 has been completed by the buffer writing control section 2201 and a timing at which the reading of the input data of one transfer unit from the buffer section 2202 has been completed by the buffer reading control section 2203 are aligned in the bus master 220 is not limited at all.

The bus interface section 2204 is an interface section for transferring the input data transferred from the buffer reading control section 2203, i.e., the DMA writing data DMAWDATA stored (written) in the DRAM 30 by the bus master 220, according to the DMA transfer. Every time input data of the transfer unit of each DMA transfer is transferred from the buffer reading control section 2203, the bus interface section 2204 generates and outputs a DMA request signal DMAREQ for requesting a DMA transfer, a DMA reading/writing signal DMARW indicating writing access, and a DMA address DMAAD and requests the DMA bus arbitration section 230 to perform the DMA transfer.

At this time, in the bus interface section 2204, the DMA address generation section 2205 generates the DMA address DMAAD. More specifically, the DMA address generation section 2205 generates the DMA address DMAAD for causing the DMA writing data DMAWDATA to be stored (written) in the DRAM 30 in accordance with the address order information output from the address order generation section 2210.

Also, as described above, the buffer reading control section 2203 transfers all input data of a transfer unit of one successive transfer, i.e., input data for eight DMA transfers, to the bus interface section 2204 in an order indicated by the address order information. Thus, input data for eight DMA transfers is not necessarily transferred from the buffer reading control section 2203 to the bus interface section 2204 in an order of banks provided in the DRAM 30. Therefore, when the input data transferred from the buffer reading control section 2203 is stored (written) as the DMA writing data DMAWDATA in the DRAM 30 by performing the DMA transfer, the DMA address generation section 2205 generates the DMA address DMAAD so that the DMA writing data DMAWDATA (input data) is stored (written) in a corresponding bank provided in the DRAM 30. Here, an example in which an operation in which the DMA address generation section 2205 generates the DMA address DMAAD is denoted by a number of one set of (eight) storage regions provided in the buffer section 2202 will be described. For example, when the buffer reading control section 2203 sequentially transfers the input data in the order of storage region numbers “3”→“1”→“0”→“2”→ . . . , the DMA address generation section 2205 generates the DMA address DMAAD so that the bank address BA is in the order of “3”→“1”→“0”→“2”→ . . . . In this manner, the DMA address generation section 2205 generates the DMA address DMAAD so that the order of input data to be transferred from the buffer reading control section 2203 to the bus interface section 2204 and the order of bank addresses BA included in the DMA address DMAAD are aligned.

The bus interface section 2204 outputs the DMA writing data DMAWDATA corresponding to the DMA address DMAAD generated by the DMA address generation section 2205 to the DMA bus arbitration section 230 together with the DMA request signal DMAREQ, the DMA reading/writing signal DMARW, and the DMA address DMAAD. Then, the bus interface section 2204 executes the requested DMA transfer every time the output DMA request is accepted by the DMA bus arbitration section 230 and the DMA permission signal DMAACK is input from the DMA bus arbitration section 230. The bus interface section 2204 successively executes eight DMA transfers for each transfer unit of one successive transfer.

When the buffer writing control section 2201 stores (saves) the input data in any one of the sets of storage regions within the buffer section 2202, the address order generation section 2210 determines an order of addresses (more specifically, bank addresses BA) when the DMA writing data DMAWDATA (input data) is stored (written) in the DRAM 30 according to eight successive DMA transfers with reference to the request acceptance history information REQHIS output from the DMA bus arbitration section 230. In other words, the address order generation section 2210 determines the order of DMA transfers of the DMA writing data DMAWDATA (input data). The address order generation section 2210 outputs address order information indicating the order of addresses when the determined DMA transfer is performed to the buffer reading control section 2203 and the DMA address generation section 2205 within the bus interface section 2204.

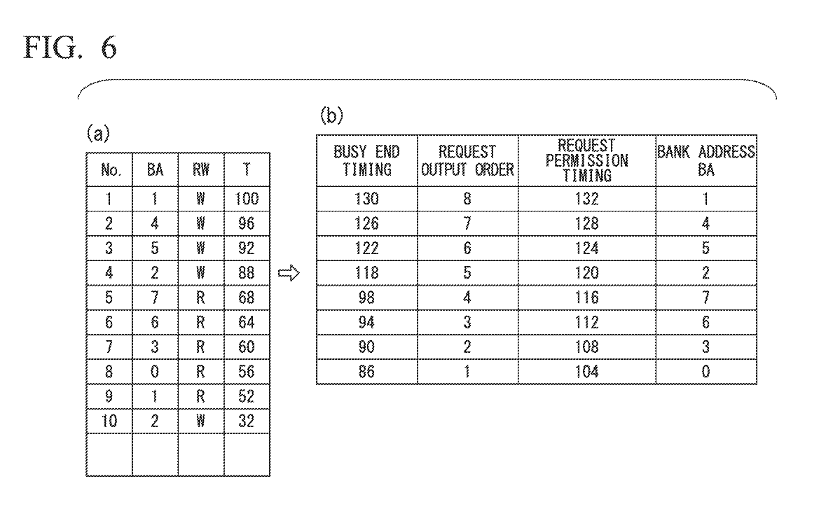

Here, a process in which the address order generation section 2210 determines the order of addresses with reference to the request acceptance history information REQHIS (hereinafter referred to as an “address order determination process”) will be described. FIG. 6 is a diagram showing a process (an address order determination process) of determines an order of addresses in which the address order generation section 2210 provided in the bus master 220 constituting the memory access control device 200 according to the first embodiment of the present invention. In (a) of FIG. 6, an example of the request acceptance history information REQHIS output from the DMA bus arbitration section 230 immediately before the bus master 220 outputs an initial DMA transfer request to the DMA bus arbitration section 230 in a transfer unit of one successive transfer is shown. Also, in (b) of FIG. 6, an example of a calculated timing and a determined order of bank addresses BA when the address order generation section 2210 determines the order of addresses is shown.

In the request acceptance history information REQHIS shown in (a) of FIG. 6, “No.” represents a number of the storage region provided in the request acceptance history storage section 2312. Request acceptance history information acquired at a time when an elapsed time measured by the counter section 2311 provided in the request acceptance history acquisition section 231 is closer to a current time when the number is smaller is stored. That is, as described above, latest request acceptance history information is stored in the storage region with the number “1”. Also, in the request acceptance history information REQHIS shown in (a) of FIG. 6, “BA” indicates information of the bank address BA output from the address generation section 2304, “RW” indicates information of the access direction signal ACCRW output from the access arbitration section 2301 (reading access is denoted by “R” and writing access is denoted by “W”), and “T” indicates information of the time T output from the counter section 2311.

For example, the request acceptance history information REQHIS-1 stored in the storage region with the number “1” indicates that the request for the DMA transfer with the access direction RW-1=W (writing access) for the bank of the bank address BA-1=1 has been accepted by the DMA bus arbitration section 230 and that the writing access to the DRAM 30 has actually been executed at the timing of a latest time T-1=100 T. Also, for example, the request acceptance history information REQHIS-5 stored in the storage region with the number “5” indicates that the request of the DMA transfer of the access direction RW-5=R (reading access) for the bank of the bank address BA-5=7 has been accepted by the DMA bus arbitration section 230 and that the writing access to the DRAM 30 has actually been executed at the timing of a previous time T-5=68 T.

The address order generation section 2210 determines an order of bank addresses BA when the bus master 220 stores (writes) the DMA writing data DMAWDATA (input data) in the DRAM 30 according to the DMA transfer in the following processing procedure with reference to the request acceptance history information REQHIS as shown in (a) of FIG. 6.

Also, in the following description, the bank busy time in each bank provided in the DRAM 30 is assumed to be 30 T. Also, in the following description, the DMA bus arbitration section 230 can arbitrate the input DMA request signal DMAREQ to accept DMA transfers to different banks, i.e., a minimum interval at which the DMA request is permitted is assumed to be 4 T. In the following description, for ease of description, it is assumed that a time required for switching the direction of access to each bank provided in the DRAM 30, i.e., the reading/writing switching time, is not considered.

(Procedure 1): First, the address order generation section 2210 calculates a busy end timing at which the bank busy time ends for each bank provided in the DRAM 30 for storing (writing) the corresponding DMA writing data DMAWDATA according to eight successive DMA transfers.

More specifically, in the request acceptance history information REQHIS shown in (a) of FIG. 6, the request acceptance history information REQHIS-8 to REQHIS-1 stored in storage regions with numbers “8” to “1” indicates accesses previously executed for the eight banks provided in the DRAM 30. Accordingly, the address order generation section 2210 calculates a busy end timing for each of the eight banks provided in the DRAM 30 as shown in (b) of FIG. 6 with reference to the request acceptance history information REQHIS-8 to REQHIS-1.

For example, a time T-8 at which the reading access of the access direction RW-8=R for the bank of the bank address BA-8=0 indicated by the request acceptance history information REQHIS-8 has actually been executed is “56 T”. The address order generation section 2210 calculates a busy end timing=56 T+30 T=86 T in the bank of the bank address BA-8=0 by adding the bank busy time=30 T to the time T-8=56 T shown in the request acceptance history in REQHIS-8. Also, for example, the time T-4 at which the writing access of the access direction RW-4=W to the bank of the bank address BA-4=2 indicated by the request acceptance history information REQHIS-4 has actually been executed is “88 T”. Likewise, the address order generation section 2210 calculates a busy end timing=88 T+30 T=118 T in the bank of the bank address BA-4=2 by adding the bank busy time=30 T to the time T-4=88 T shown in the request acceptance history information REQHIS-4. Likewise, the address order generation section 2210 calculates a busy end timing in each bank as shown in (b) of FIG. 6. Then, the address order generation section 2210 calculates a busy end timing=100 T+30 T=130 T in the bank of the bank address BA-1=1 indicated by the latest request acceptance history information REQHIS-1, i.e., the bank of the bank address BA-1=1 most recently accessed in the DRAM 30.

(Procedure 2): Subsequently, the address order generation section 2210 determines a temporary request output order in the ascending order of busy end timings calculated in the procedure 1.

More specifically, the address order generation section 2210 temporarily determines the bank of the bank address BA-8=0 in which the busy end timing is an earliest busy end timing=86 T shown in (b) of FIG. 6 in a request output order=1. Thereafter, the address order generation section 2210 temporarily determines banks of bank addresses BA-7=3 to BA-1=1 sequentially in a request output order=2 to 8.

(Procedure 3): Subsequently, when the DMA transfer is requested in the request output order temporarily determined in the procedure 2, the address order generation section 2210 sequentially calculates request permission timings at which the DMA request has been accepted in a shortest time by the DMA bus arbitration section 230.

More specifically the address order generation section 2210 sequentially calculates request permission timings from the bank of the bank address BA-8=0 temporarily determined in the request output order=1. In this case, the address order generation section 2210 calculates a request permission timing=100 T+4 T=104 T for the bank of the bank address BA-8=0 by adding 4 T of a minimum interval at which the DMA request is permitted to a time T-1=100 T at which most recent access to the DRAM 30 has actually been executed indicated by the request acceptance history information REQHIS-1 in (a) of FIG. 6. Subsequently, the address order generation section 2210 calculates a request permission timing=104 T+4 T=108 T for the bank of the bank address BA-7=3 temporarily determined in the request output order=2 by replacing the latest time T-1 with the request permission timing=104 T for the bank of the calculated bank address BA-8=0 and similarly adding 4 T of a minimum interval at which the DMA request is permitted to 104 T. Thereafter, likewise, the address order generation section 2210 replaces the latest time T-1 with the calculated request permission timing and sequentially calculates request permission timings when DMA requests have been sequentially accepted for banks in the temporarily determined request output order as shown in (b) of FIG. 6.

(Procedure 4): Subsequently, the address order generation section 2210 compares the busy end timing calculated in the procedure 1 with the request permission timing calculated in the procedure 3 in the request output order temporarily determined in the procedure 2 and determines the final request output order, i.e., an order of banks to be accessed in the DMA transfer.

More specifically, when the busy end timing is earlier than or equal to the request permission timing, the address order generation section 2210 determines that the DMA request output at the same time when the bank busy time has elapsed or after the passage of the bank busy time is accepted by the DMA bus arbitration section 230. That is, even if a DMA request for accessing the bank for which the busy end timing and the request permission timing have been compared is output, the address order generation section 2210 determines that the DMA transfer access to the DRAM 30 is actually executed without the bank busy time. In this case, the address order generation section 2210 determines each bank of the request output order temporarily determined in the procedure 2 in a final order of banks to be accessed in the DMA transfer. Then, the address order generation section 2210 outputs address order information indicating the determined order of banks to the buffer reading control section 2203 and the DMA address generation section 2205.

In the example shown in (b) of FIG. 6, all busy end timings calculated in the procedure 1 are earlier than the corresponding request permission timings calculated in the procedure 3. Accordingly, in the example shown in (b) of FIG. 6, the address order generation section 2210 determines each bank of the request output order temporarily determined in the procedure 2 as the final order of banks and outputs the address order information indicating the order of banks to the buffer reading control section 2203 and the DMA address generation section 2205. More specifically address order information indicating that the order of bank addresses BA is the order of “0”, “3”, “6”, “7”, “2”, “5”, “4”, and “1” is output to the buffer reading control section 2203 and the DMA address generation section 2205. Also, in the example shown in (b) of FIG. 6, a final order of banks determined by the address order generation section 2210 becomes a history order from oldest to newest in a history of access to the DRAM 30 shown in the request acceptance history information REQHIS shown in (a) of FIG. 6.

On the other hand, if the busy end timing is later than the request permission timing, the address order generation section 2210 determines that acceptance of the output DMA request by the DMA bus arbitration section 230 is on standby for a time of a difference between the busy end timing and the request permission timing and the output DMA request is accepted when the bank busy time has elapsed. That is, the address order generation section 2210 determines that the output of the DMA request for accessing a bank for which the busy end timing is compared with the request permission timing is on standby until the bank busy state ends, actual access of the DMA transfer for the DRAM 30 is delayed, and the efficiency of access to the DRAM 30 is lowered. In this case, the address order generation section 2210 changes an order of request outputs temporarily determined in the procedure 2. Then, the address order generation section 2210 searches for a request output order in which it can be determined that the actual access of the DMA transfer to the DRAM 30 is executed without the bank busy time by re-calculating the request permission timing in the procedure 3 for the changed request output order and comparing the busy end timing with the calculated request permission timing. That is, the address order generation section 2210 iterates a processing procedure of each of a change in the temporarily determined request output order, the procedure 3, and the procedure 4 to determine a final order of banks to be accessed in the DMA transfer.

Also, the number of iterations of the above-described processing procedure for the address order generation section 2210 to search for the request output order which is not subject to the bank busy time may be the predetermined number of times. This is because, although the address order generation section 2210 can search for a request output order which is not subject to the bank busy time by iterating the above-described processing procedure, the iteration of the above-described processing procedure is time-consuming and can cause the efficiency of access to the DRAM 30 to be lowered. Also, another example of the request output order in the address order generation section 2210 will be described below.

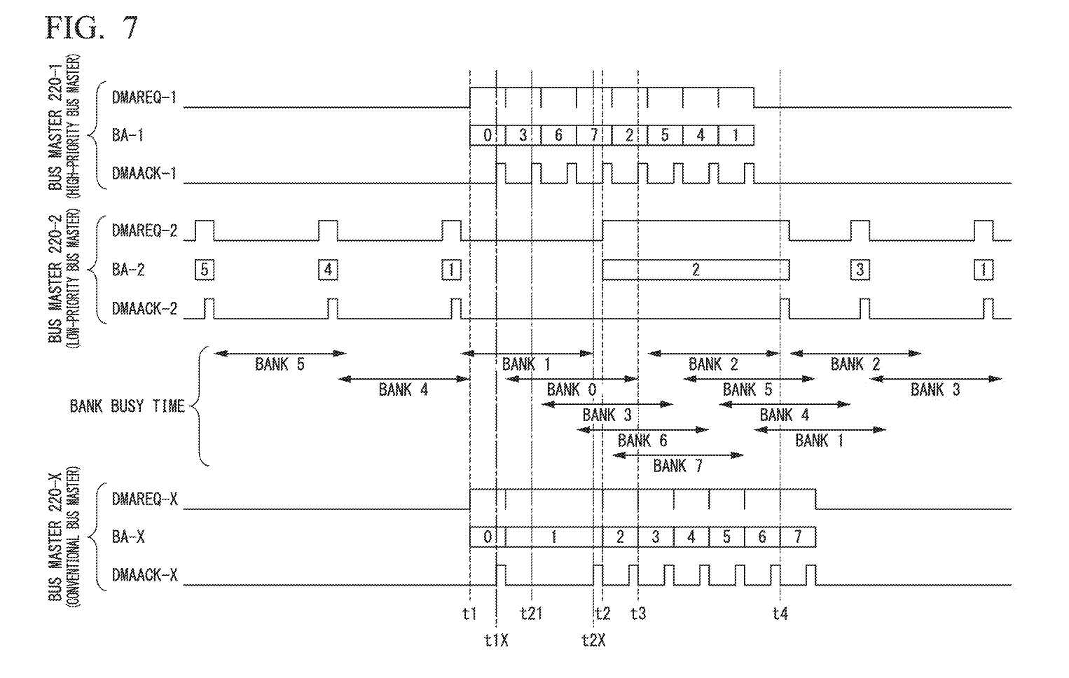

Next, an operation of the memory access control device 200 will be described. FIG. 7 is a timing chart showing an example of an access timing of the DRAM 30 by the memory access control device 200 according to the first embodiment of the present invention. In FIG. 7, an example of a timing of a control signal when the DMA bus arbitration section 230 actually accesses the DRAM 30 in response to the DMA request from each of the two bus masters 220 is shown. More specifically, an example of timings when the memory access control device 200 includes a high-priority bus master 220 having a configuration shown in FIG. 5 in which eight DMA transfers are successively performed in one successive transfer, a low-priority bus master 220 configured to perform one DMA transfer for each bank provided in the DRAM 30, and the DMA bus arbitration section 230 is shown. Also, in FIG. 7, the bank busy time indicating whether or not each bank provided in the DRAM 30 is in the bank busy state is shown together therewith. In the following description, a bus master 220 with a high priority (a high-priority bus master) will be described as a “bus master 220-1” and a bus master 220 with a low priority (hereinafter referred to as a “low-priority bus master”) will be described as a “bus master 220-2”. Also, the low-priority bus master may not have a function of determining the order of bank addresses BA to be accessed in the DMA transfer with reference to the request acceptance history information REQHIS.

In the timing chart shown in FIG. 7, the DMA bus arbitration section 230 executes the DMA transfer for the bank specified from the bus master 220-2 in accordance with the DMA request signal DMAREQ-2 output from the bus master 220-2. When the DATA bus arbitration section 230 executes the DMA transfer control in response to the DMA request from the bus master 220-2, the bank of the DRAM 30 specified from the bus master 220-2 is in the bank busy state, and a state in which the same bank can be re-accessed is reached after the bank busy time elapses.

Thereafter, when the bus master 220-1 outputs the DMA request signal DMAREQ-1 at a timing t1, the DMA bus arbitration section 230 executes the DMA transfer from the bus master 220-1 to a specified bank. Also, the bus master 220-1 determines an order of bank addresses BA to be accessed in each DMA transfer with reference to the request acceptance history information REQHIS output from the DMA bus arbitration section 230 immediately before one successive transfer starts, and successively DMA request signals DMAREQ-2 in which banks are specified in the determined order.

In FIG. 7, the bus master 220-1 specifies banks provided in the DRAM 30 in the order of bank addresses BA shown in (b) of FIG. 6 determined with reference to the request acceptance history information REQHIS shown in (a) of FIG. 6. Thereby, as shown in FIG. 7, the bus master 220-1 can perform eight DMA transfers by avoiding access to a bank in the bank busy state in one successive transfer. That is, the bus master 220-1 can successively perform DMA transfers in the order in which access restrictions in the DRAM 30 are avoided. Thereby, the bus master 220-1 can access the DRAM 30 in a state of high access efficiency.

Also, in FIG. 7, a case in which the bus master 220-2 outputs a new DMA request signal DMAREQ-2 for specifying the bank of the bank address BA-2=2 at a timing t2, i.e., while the bus, master 220-1 is outputting the DMA request signal DMAREQ-1 in one successive transfer, is shown. However, the bus master 220-2 is a low-priority bus master having a lower priority than the bus master 220-1. Therefore, even though the DMA request signal DMAREQ-2 output by the bus master 220-2 is a DMA request for specifying the bank of the bank address BA-2=2 which is not in the bank busy state, the DMA bus arbitration section 230 outputs the DMA permission signal DMAACK-1 for continuously accepting the DMA request signal DMAREQ-1 output from the bus master 220-1 at a timing t3 without accepting the DMA request from the bus master 220-2. Then, DMA bus arbitration section 230 outputs a DMA permission signal DMAACK-2 for accepting the DMA request signal DMAREQ-2 output from the bus master 220-2 at a timing t4 after a bank busy time of the bank of the bank address BA=2 elapses when there is no DMA request from the bus master 220-1.

According to such a configuration and operation, the memory access control device 200 performs a DMA transfer for avoiding access to a bank in the bank busy state provided in the DRAM 30. Thereby, the memory access control device 200 can improve the efficiency of access to the DRAM 30.

Also, in FIG. 7, a bus master 220-X is shown as a reference in an example of a timing of an operation in which the bus master 220-1 successively requests eight DMA transfers without changing an order of bank addresses BA to be accessed in one successive transfer. The timing of the operation of the bus master 220-X corresponds to the timing of the operation in which the conventional bus master successively requests eight DMA transfers.

Similar to the, bus master 220-1, the bus master 220-X shown as the reference in FIG. 7 starts one successive transfer from a timing t1 and sequentially outputs DMA request signals DMAREQ-X for sequentially specifying banks of bank addresses BA-X=0 to BA-X=7 to the DMA bus arbitration section 230. Thereby, the DMA bus arbitration section 230 accepts the DMA request from the bus master 220-X in preference to the bus master 220-2 and outputs a DMA permission signal DMAACK-X.

Here, a timing of one successive transfer of the bus master 220-1 is compared with a timing of one successive transfer of the bus master 220-X. In a first DMA transfer in the one successive transfer, as shown in FIG. 7, the DMA request signal DMAREQ-X for specifying the bank of the bank address BA-X=0 output by the bus master 220-X is also accepted at a timing t1X as in the bus master 220-1.

However, in the second DMA transfer, as shown in FIG. 7, a timing at which the DMA request output by the bus master 220-X is accepted is later than a timing at which the DMA request output by the bus master 220-1 is accepted. More specifically, the DMA request signal DMAREQ-1 for specifying the bank of the bank address BA-1=3 output by the bus master 220-1 is accepted at a timing t21. On the other hand, the DMA request signal DMAREQ-X for specifying the bank of the bank address BA-X=1 output by the bus master 220-X is accepted at a timing t2X later than the timing t21. This is because the bank of the bank address BA-X=1 specified by the bus master 220-X as the bank for performing the DMA transfer is in the bank busy state due to accessing the bank in the bus master 220-2 at a timing before the timing t1 at which the bus muster 220-X starts one successive transfer and therefore it waits until the timing t2X at which the bank busy time elapses. Thereby, a timing at which one successive transfer, i.e., eight DMA transfers, is completed in the bus master 220-X is later than that in the bus master 220-1.

In this manner, in the memory access control device 200, an order in which banks provided in the DRAM 30 are accessed is changed with reference to the request acceptance history information REQHIS immediately before the start of one successive transfer, so that a bank in the bank busy state is not specified in each DMA transfer. Thereby, the memory access control device 200 can also improve the efficiency of access to the DRAM 30 and shorten a period until a series of DMA transfers is completed.

Also, in the above description, an example in which the direction of access to the DRAM 30 according to the DMA transfer to be executed by the bus master 220 provided in the memory access control device 200 according to the first embodiment of the present invention is only writing access (data writing) has been described with reference to FIGS. 5 to 7. However, the bus master 220 provided in the memory access control device 200 may include a bus master configured to perform a DMA transfer in which the direction of access to the DRAM 30 is only reading access (data reading) or a bus master configured to perform a DMA transfer in which the direction of access to the DRAM 30 is both writing access and reading access.

A configuration and an operation of the bus master 220 in which the direction of access to the DRAM 30 is only reading access (data reading) can be easily conceived by reversing the direction of access to the DRAM 30, i.e., only changing the writing access to the reading access, in the bus master 220 configured to perform only the writing access (data writing) shown in FIGS. 5 to 7. Also, a configuration and an operation of the bus master 220 in which the direction of access to the DRAM 30 is both writing access and reading access can be easily conceived by conceiving a configuration which further includes a configuration corresponding to reading access in the bus master 220 configured to perform only writing access (data writing) shown in FIGS. 5 to 7. Accordingly, detailed description of configurations and operations in the bus master 220 in which the direction of access to the DRAM 30 is only reading access and the bus master 220 in which the direction of access to the DRAM 30 is both writing access and reading access will be omitted.

However, in the above description, for ease of description, a case in which a time required for switching the direction of access to each bank provided in the DRAM 30 (a reading/writing switching time) is not considered in an address order determination process in which the address order generation section 2210 shown in FIG. 6 determines an order of addresses with reference to the request acceptance history information REQHIS has been described. However, in an actual operation of the memory access control device 200 according to the first embodiment of the present invention, it is necessary to consider the reading/writing switching time. Accordingly, in the following description, an address order determination process in which the address order generation section 2210 provided in the bus master 220 determines an order of addresses in consideration of the reading/writing switching time will be described. Also, in the following description, an example in which the address order generation section 2210 configured to perform the address order determination process of determining the order of addresses (more specifically, bank addresses BA) in consideration of the reading/writing switching time is provided in the bus master 220 in which the direction of access to the DRAM 30 is both the writing access and the reading access will be described.

### (First Modified Example of Address Order Determination Process)

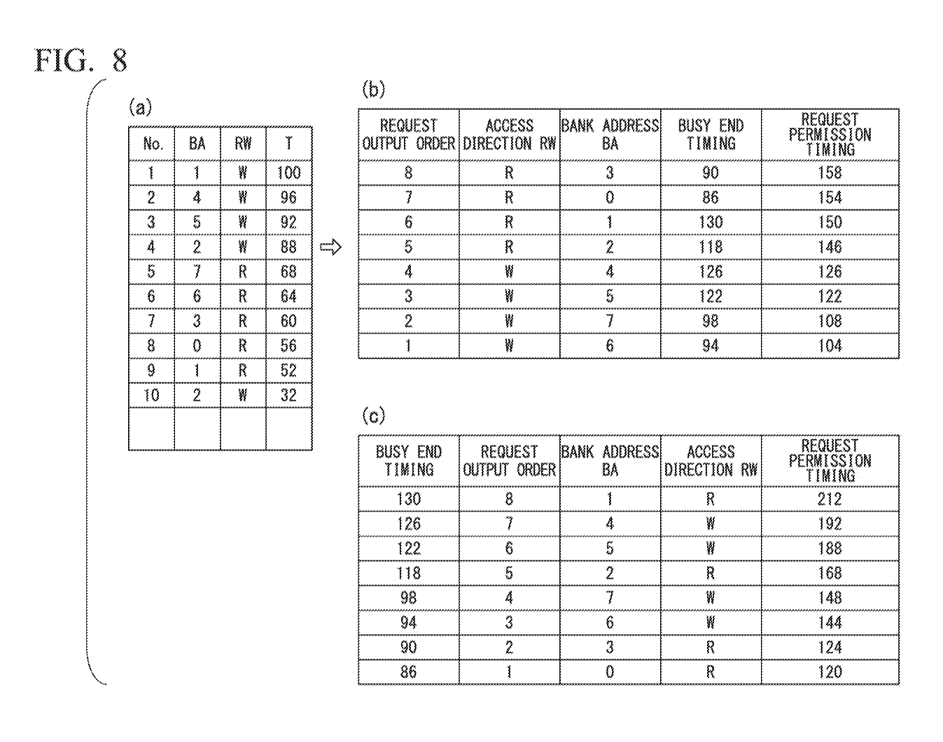

FIG. 8 is a diagram showing another process (address order determination process) of determines an order of addresses in which the address order generation section 2210 provided in the bus master 220 constituting the memory access control device 200 according to the first embodiment of the present invention. FIG. 8 is an example of the address order determination process in which the address order generation section 2210 provided in the bus master 220 in which the direction of access to the DRAM 30 is both the writing access and the reading access determines an order of addresses with reference to the request acceptance history information REQHIS. In (a) of FIG. 8, an example of the request acceptance history information REQHIS output from the DMA bus arbitration section 230 immediately before the bus master 220 outputs an initial DMA transfer request to the DMA bus arbitration section 230 in a transfer unit of one successive transfer is shown. Also, because (a) of FIG. 8 is the same as an example of the request acceptance history information REQHIS shown in (a) of FIG. 6, detailed description thereof will be omitted. Also, in (b) of FIG. 8, examples of a calculated timing and a determined order of bank addresses BA when the address order generation section 2210 determines an order of addresses in the first modified example of the address order determination process are shown. Also, in (c) of FIG. 8, an example of a case in which the address order generation section 2210 determines the order of bank addresses BA in the address order determination process described in (b) of FIG. 6, i.e., a case in which an order of bank addresses BA is determined to be a history order from oldest to newest in a history in which the DRAM 30 is accessed indicated by the request acceptance history information REQHIS shown in (a) of FIG. 8, is shown as a reference.

Also, “No”, “BA”, “RW”, and “T” shown in (a) of FIG. 8 are similar to those shown in (a) of FIG. 6. Also, the “busy end timing”, the “request output order”, the “request permission timing”, and the “bank address BA” shown in (b) and (c) of FIG. 8 are similar to those shown in (b) of FIG. 6. Also, the “access direction RW” shown in (b) and (c) of FIG. 8 represents a direction of access to each bank provided in the DRAM 30, “R” indicates the reading access, and “W” indicates, the writing access.

In the first modified example of the address order determination process, the address order generation section 2210 determines an order of bank addresses BA for reducing the switching of the direction of access to each bank provided in the DRAM 30 according to the following processing procedure with reference to information of the access direction signal ACCRW included in the request acceptance history information REQHIS as shown in (a) of FIG. 8. In other words, in the first modified example of the address order determining process, the order of bank addresses BA to be accessed by the bus master 220 to the DRAM 30 becomes an order for reducing the switching between the reading access and the writing access instead of an access history order from oldest to newest.

Also, in the following description, as in an example of the bus master 220 configured to perform only the above-described writing access (data writing), the bank busy time in each bank of the DRAM 30 is to be assumed to be 30 T and a minimum interval at which the DMA request is permitted in the DMA bus arbitration section 230 is assumed to be 4 T. Also, in the following description, the reading/writing switching time when the direction of access to each bank provided in the DRAM 30 is switched is assumed to be 20 T. In the following description, it is assumed that the reading access to bank addresses BA=0 to 3 is performed and the writing access to bank addresses BA=4 to 7 is performed.

(Procedure A): First, in the eight successive DMA transfers, the address order generation section 2210 determines a temporary request output order so that accesses are first collectively performed in the same direction as the access direction of most recent access to the DRAM 30 and accesses are subsequently collectively performed in a direction different from the access direction of most recent access to the DRAM 30.

More specifically, in the request acceptance history information REQHIS-1 shown in (a) of FIG. 8, the writing access actually performed in an access direction RW-1=W for the bank of the bank address BA-1=1 is shown. Accordingly, the address order generation section 2210 temporarily determines the request output order so that writing accesses are first collectively performed and reading accesses are subsequently collectively performed as shown in (b) of FIG. 8 with reference to the access direction RW included in the request acceptance history information REQHIS-8 to REQHIS-1. In the example shown in (b) of FIG. 8, an example in which the order of bank addresses BA is set to an order of “6”, “7”, “5”, and “4” in order from an oldest writing access history and then an order of bank addresses BA in the reading access is set to an order of “2”, “1”, “0”, and “3” is shown.

(Procedure B): Subsequently, the address order generation section 2210 calculates a busy end timing at which the bank busy time ends for each bank with reference to the request acceptance history information REQHIS shown in (a) of FIG. 6. Also, a method of calculating the busy end timing in the procedure B is similar to that in the procedure 1 described above. That is, also in procedure B, the address order generation section 2210 calculates a busy end timing by adding a bank busy time=30 T to the time T at which the access to each bank has actually been executed. Accordingly, the process of the procedure B may be performed before the procedure A.

(Procedure C): Subsequently, when the DMA transfer is requested in the request output order temporarily determined in the procedure A, the address order generation section 2210 sequentially calculates request permission timings when the DMA request has been accepted in a shortest time by the DMA bus arbitration section 230. Also, the method of calculating the request permission timing in the procedure C is also similar to that in the procedure 3 described above. However, in the first modified example of the address order determination process, a reading/writing switching time is considered. When the request permission timing calculated in the procedure C is a request permission timing of a request for the bank to be accessed in a different direction of access to the DRAM 30, the address order generation section 2210 calculates a request permission timing by adding 20 T of the reading/writing switching time instead of 4 T of a minimum interval at which the DMA request is permitted.

More specifically, the bank of the bank address BA=2 temporarily determined in the request output order=5 is a bank for which the access direction is switched from writing access to reading access. Thus, the address order generation section 2210 calculates a request permission timing=126 T+20 T=146 T by adding 20 T of the reading/writing, switching time to a request permission timing=126 T calculated in the bank of the bank address BA=4 temporarily determined in the request output order=4. Thereafter, likewise, the address order generation section 2210 sequentially calculates request permission timings when DMA requests have been sequentially accepted for banks in a temporarily determined request output order as shown in (b) of FIG. 8 by adding 4 T of a minimum interval at which the DMA request is permitted or 20 T of the reading/writing switching time to the calculated latest request permission timing.

Also, as shown in (b) of FIG. 8, for the bank of the bank address BA=5 temporarily determined in the request output order=3 and the bank of the bank address BA=4 temporarily determined in the request output order=4, the calculated request permission timing is not a timing obtained by adding 4 T of a minimum interval at which the DMA request is permitted or 20 T of the reading/writing switching time to the calculated latest request permission timing. Then, for the bank of the bank address BA=5 temporarily determined in the request output order=3 and the bank of the bank address BA=4 temporarily determined in the request output order=4, the calculated request permission timing is set as a busy end timing calculated before the procedure B or the procedure A. In theory, because the bank of the bank address BA=5 temporarily determined in the request output order=3 and the bank of the bank address BA=4 temporarily determined in the request output order=4 is subjected to the same writing access as an immediately previous access, it is possible to calculate each request permission timing by adding 4 T of the minimum interval at which the DMA request is permitted. However, because each calculated request permission timing is a timing before the busy end timing, i.e., within a period of 30 T of the bank busy time in each bank, the DMA request for each bank is not accepted at the minimum interval 4 T. Thus, the request permission timing becomes a busy end timing at which the bank busy time ends.

More specifically, for example, for the bank of the bank address BA=5 temporarily determined in the request output order=3, a request permission timing=108 T+4 T=112 T is calculated by adding 4 T of the minimum interval at which the DMA request is permitted to a request permission timing=108 T calculated in the bank of the bank address BA=7 temporarily determined in the request output order=2. However, because a time T-3 at which the access to the bank of the bank address BA=5 temporarily determined in the request output order=3 has actually been executed is “92 T”, a busy end timing=92 T+30 T=122 T in the bank of the bank address BA-3=5 is calculated by adding a bank busy time=30 T to the time T-3=92 T indicated by the request acceptance history information REQHIS-3. Thus, a request permission timing of the bank of the bank address BA=5 temporarily determined in the request output order=3 becomes “122 T”.

(Procedure D): Subsequently, the address order generation section 2210 determines an final request output order, i.e., an order of banks to be accessed in the DMA transfer. A method of determining the final request output order in the procedure D is similar to that in the procedure 4 described above. That is, also in the procedure D, the address order generation section 2210 compares the busy end timing calculated before the procedure B or the procedure A with the request permission timing, calculated in the procedure C in the request output order temporarily determined in the procedure A and determines each bank of the temporarily determined request output order in a final order of banks to be accessed in the DMA transfer when the busy end timing is earlier than or equal to the request permission timing.

In this manner, in the first modified example of the address order determination process, the address order generation section 2210 determines an order of bank addresses BA so that access in the same direction as an access direction of most recent access, is first performed and access in a direction different from an access direction of most recent access is subsequently performed to reduce the switching of the direction of access to each bank provided in the DRAM 30. Thereby, in the first modified example of the address order determination process, a series of DMA transfers in one, successive transfer can be completed without lowering the efficiency of access to the DRAM 30.

Here, for comparison, an example in which the address order generation section 2210 determines an order of bank addresses BA as a history order from oldest to newest in a history of access to the DRAM 30 indicated by the request acceptance history information REQHIS shown in (a) of FIG. 8 by using (c) of FIG. 8 will be described. Also, the processing procedure of the address order determination process of determining the order of bank addresses BA as a history order from oldest to newest in a history of access shown in (c) of FIG. 8 is similar to the processing procedure of the address order determination process described in FIG. 6. Accordingly, in (c) of FIG. 8, as in the example shown in (b) of FIG. 6, the order of bank addresses BA is determined in the order “0”, “3”, “6”, “7”, “2”, “5”, “4”, and “1”.

However, in the example shown in (c) of FIG. 8, the request permission timing is calculated together with the reading/writing switching time. Thus, in the example shown in (c) of FIG. 8, at the time of the bank in which the access direction is switched from the writing access to the reading access or the bank in which the access direction is switched from the reading access to the writing access, the request permission timing is calculated by adding 20 T of the reading/writing switching time instead of 4 T of the minimum interval at which the DMA request is permitted.

More specifically, for example, the bank of the bank address BA-8=0 temporarily determined in the request output order=1 is a bank in which the access direction is switched from the writing access to the reading access. Thus, the address order generation section 2210 calculates a request permission timing=100 T+20 T=120 T by adding 20 T of the reading/writing switching time to a time T-1=100 T at which most recent access to the DRAM 30 has actually been executed indicated by the request acceptance history information REQHIS-1 in (a) of FIG. 8. Also, for example, the bank of the bank address BA-6=6 temporarily determined in the request output order=3 is a bank in which the access direction is switched from the reading access to the writing access. Thus, the address order generation section 2210 calculates a request permission timing=124 T+20 T=144 T by similarly adding 20 T of the reading/writing switching time to a request permission timing=124 T calculated in the bank of the bank address BA-7=3 temporarily determined in the request output order=2. Also, for example, the bank of the bank address BA-4=2 temporarily determined in the request output order=5 is a bank in which the access direction is re-switched from the writing access to the reading access. Thus, the address order generation section 2210 calculates a request permission timing=148 T+20 T=168 T by similarly adding 20 T of the reading/writing switching time to a request permission timing=148 T calculated in the bank of the bank address BA-5=7 temporarily determined in the request output order=4.

Also, in the example shown in (c) of FIG. 8, all busy end timings are earlier than or equal to the corresponding request permission timing. Accordingly, the address order generation section 2210 can determine an order of bank addresses BA shown in (c) of FIG. 8, i.e., a history order from oldest to newest in a history of access to the DRAM 30 indicated by the request acceptance history information REQHIS shown in (a) of FIG. 8, as a final order of bank addresses BA. However, in the example shown in (c) of FIG. 8, the request permission timing at which a last DMA transfer in one successive transfer, i.e., an eighth DMA request, is permitted is later than when an order of bank addresses BA is determined so that the switching of the direction of access to each bank provided in the DRAM 30 shown in b) of FIG. 8 is reduced. More specifically, while a request permission timing at the bank address BA=3 of the request output order=8 is “158 T” in the example shown in (b) of FIG. 8, a request permission timing at the bank address BA=1 of the request output order=8 is “212 T” in the example shown in (c) of FIG. 8. Thus, the address order generation section 2210 can complete a series of DMA transfers in one successive transfer at an earlier time in a method of determining each bank of the request output order (see (b) of FIG. 8) temporarily determined in the procedure A in a final order of banks.

### (Second Modified Example of Address Order Determination Process)

In the above description of the first modified example of the address order determination process, a case in which a request output order is temporarily determined so that access in the same direction as an access direction of most recent access to the DRAM 30 is first performed and access in a direction different from the access direction of most recent access to the DRAM 30 is subsequently performed has been described. However, the order of bank addresses BA fore completing a series of DMA transfers at an earlier time differs according to various conditions such as the specification of the DRAM 30 and the order of access to the DRAM 30. Thus, the address order generation section 2210 may be configured to calculate a plurality of types of orders of bank addresses BA and determine an order for completing a series of DMA transfers in one successive transfer among the calculated orders of bank addresses BA at the earliest time as a final order of banks.

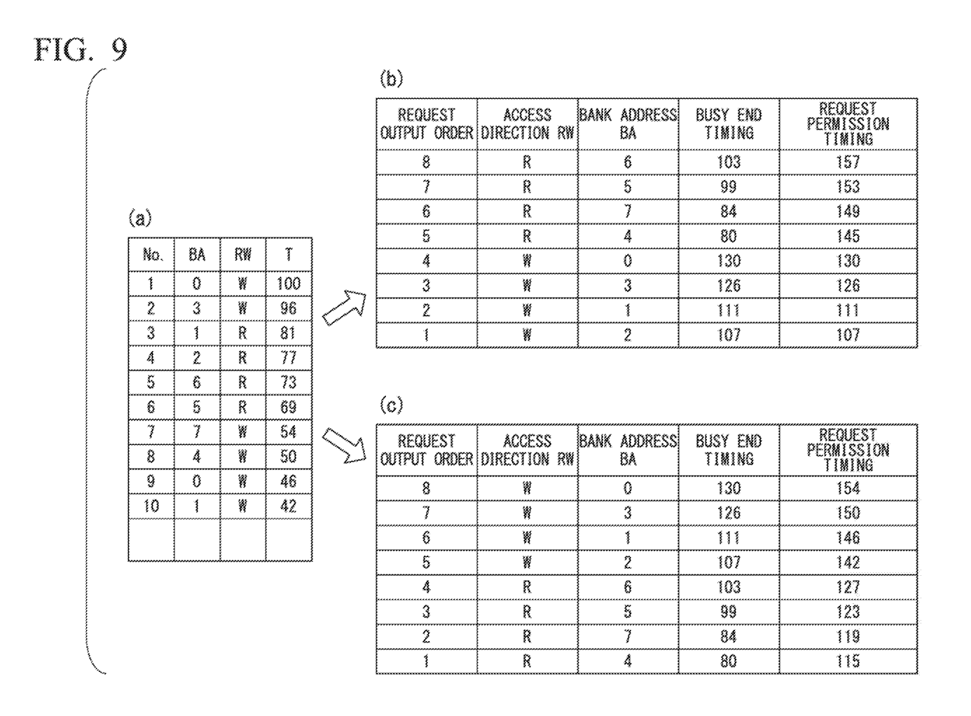

FIG. 9 is a diagram showing further another process (address order determination process) of determining the order of addresses in which the address order generation section 2210 provided in the bus master 220 constituting the memory access control device 200 according to the first embodiment of the present invention As in the first modified example of the address order determination process shown in FIG. 8, FIG. 9 is also an example in which the address order generation section 2210 provided in the bus master 220 in which the direction of access to the DRAM 30 is both the writing access and the reading access determines an order of addresses with reference to the request acceptance history information REQHIS. In (a) of FIG. 9, an example of the request acceptance history information REQHIS output from the DMA bus arbitration section 230 immediately before the bus master 220 outputs an initial DMA transfer request to the DMA bus arbitration section 230 in a transfer unit in one successive transfer is shown. Also, in (b) of FIG. 9, an example in which the address order generation section 2210 determines an order of bank addresses BA so that an order for reducing the switching between the reading access and the writing access is provided as in the address order determination process of the first modified example of the first embodiment is shown. Also, in (c) of FIG. 9, an example in which the order of bank addresses BA is determined so that the address order generation section 2210 combines accesses in the same direction as in the address order determination process of the first modified example of the first embodiment, but a period required for the bank busy time is shortened is shown.

Also, “No.”, “BA”, “RW”, and “T” shown in (a) of FIG. 9 are similar to those in (a) of FIG. 8. Also, the “busy end timing”, the “request output order”, the “request permission timing”, the “bank address BA”, and the “access direction RW” shown in (b) and (c) of FIG. 9 are similar to those shown in (b) of FIG. 8.

Also, in the following description, the bank busy time is to be assumed to be 30 T and a minimum interval at which the DMA request is permitted is assumed to be 4 T as in the first modified example of the address order determination process. However, in the second modified example of the address order determination process, the reading/writing switching time is assumed to be 15 T. The access direction of each bank is assumed to be similar to that of the first modified example of the address order determination process. That is, also in the second modified example of the address order determination process, it is assumed that the reading access to the bank addresses BA=0 to 3 is performed and the writing access to the bank addresses BA=4 to 7 is performed.

In the second modified example of the address order determination process, as in the first modified example of the address order determination process, the address order generation section 2210 also temporarily determines the request output order with reference to information of the access direction signal ACCRW included in the request acceptance history information REQHIS as shown in (a) of FIG. 9. In the second modified example of the address order determination process, as in the first modified example of the address order determination process, the address order generation section 2210 also calculates and compares the busy end timing and the request permission timing to determine a final order of banks. Also, the processing procedure in the second modified example of the address order determination process is similar to the processing procedure in the first modified example of the address order determination process. However in the second modified example of the address order determination process, the address order generation section 2210 temporarily determines a plurality of types of request output orders in the procedure A. In the second modified example of the address order determination process, the address order generation section 2210 determines a request output order in which the efficiency of access to the DRAM 30 is higher and a series of DMA transfers in one successive transfer can be completed at an earlier time as a final order of banks by performing the processing of procedures B and C with respect to each temporarily determined request output order. Also, the address order generation section 2210 may simultaneously perform the processing of procedures B and C for each determined request output order in parallel.

Here, a case in which the address order generation section 2210 performs the address order determination process with reference to the request acceptance history information REQHIS indicating that the DMA transfer between the bus master 220 and the DRAM 30 has actually been performed in the order of bank addresses “1”, “0”, “4”, “7”, “5”, “6”, “7”, “1”, “3”, and “0” as shown in (a) of FIG. 9 is conceived. In the procedure A, the address order generation section 2210 temporarily determines a plurality of types of request output orders with reference to the information of the access direction signal ACCRW included in the request acceptance history information REQHIS.

In (b) of FIG. 9, after the address order generation section 2210 combines accesses in the same direction in the procedure A, a request output order determined in preferential consideration of an access direction of most recent access and reduction of switching between the reading access and the writing access and a busy end timing and a request permission timing calculated by performing the processing of the procedures B and C with respect to the request output order are shown. More specifically, in (b) of FIG. 9, a request output order for performing the same writing access as a direction of most recent access to the DRAM 30 in an order of bank addresses BA of “2”, “1”, “3”, and “0” and subsequently performing the reading access in an order of bank addresses BA of “4”, “7”, “5”, and “6” is shown. In the example shown in (b) of FIG. 9, the request permission timing at the bank address BA=6 of the request output order=8 is “157 T”.

Also, in (c) of FIG. 9, after the address order generation section 2210 combines accesses in the same direction in the procedure A, a request output order determined in consideration of a history order from oldest to newest in a history of access indicated by the request acceptance history information REQHIS of (a) of FIG. 9 preferentially and a busy end timing and a request permission timing calculated by performing the processing of the procedures B and C with respect to the request output order are shown. More specifically, in (c) of FIG. 9, a request output order for performing the reading access in an order of bank addresses BA of “4”, “7”, “5”, and “6” and subsequently performing the writing access in an order of bank addresses BA of “2”, “1”, “3”, and “0” is shown. In the example shown in (c) of FIG. 9, a request permission timing at the bank address BA=0 of the request output order=8 is “154 T”.

In this case, the address order generation section 2210 determines a request output order of an example shown in (c) of FIG. 9 in which the DMA request for the bank address BA of the request output order=8 is accepted at an earlier time as a final order of banks.

In this manner, in the second modified example of the address order determination process, the address order generation section 2210 temporarily determines a plurality of types of request output orders and calculates a request permission timing for each temporarily determined request output order. In the second modified example of the address order determination process, the address order generation section 2210 determines a request output order in which the DMA requests are accepted at an earlier time as the final order of banks at the calculated request permission timing. Thereby, in the second modified example of the address order determining process, a series of DMA transfers in one successive transfer can be completed at an earlier time.

According to the first embodiment, there is provided a memory access control device (the memory access control device 200), including: a plurality of bus masters (bus masters 220) configured to output an access request (a DMA request) to a memory (the DRAM 30) in which an address space is divided into a plurality of banks; an arbiter (the DMA bus arbitration section 230) connected to the DRAM 30 and configured to arbitrate the DMA request output from each of the bus masters 220 and control access to the DRAM 30 in response to the DMA request which has been accepted; and a request acceptance history acquisition section (the request acceptance history acquisition section 231) configured to acquire information about a plurality of DMA requests accepted by the DMA bus arbitration section 230 (request acceptance history information), store the acquired information as the request acceptance history information (the request acceptance history information REQHIS), and output the stored request acceptance history information REQHIS, wherein, when at least one bus master 220 with a high priority among the plurality of bus masters 220 is defined as a high-priority bus master (for example, the bus master 220-1), the bus master 220-1 is configured to determine an order of banks specified according to each DMA request (more specifically, an order of bank addresses BA) with reference to the request acceptance history information REQHIS when the plurality of banks of the DRAM 30 are successively accessed and output the DMA request for specifying the banks in the determined order.

Also, according to the first embodiment, the memory access control device 200 in which the request acceptance history acquisition section 231 is configured to store the request acceptance history information REQHIS including information of the bank (information of a bank address BA) specified in the DMA request and information indicating a direction of access to the DRAM 30 (information of an access direction RW) are associated for each DMA request accepted by the DMA bus arbitration section 230 and the bus master 220-1 is configured to determine the order of bank addresses BA specified according to each DMA request on the basis of the information of the bank address BA included in the request acceptance history information REQHIS and avoiding access within a predetermined time (a bank busy time) for the same bank is configured.

Also, according to the present first embodiment, the memory access control device 200 in which the request acceptance history acquisition section 231 is further configured to acquire information indicating a timing at which the DMA request has been accepted by the DMA bus arbitration section 230 (information of a time T), and the request acceptance history information REQHIS is including the acquired information of the time T is configured.

Also, according to the first embodiment, the memory access control device 200 in which the request acceptance history acquisition section 231 is configured to store a predetermined number of pieces of the request acceptance history information REQHIS going back from the DMA request most recently accepted by the DMA bus arbitration section 230 (for example, equal in number to banks provided in the DRAM 30) or the request acceptance history information REQHIS for a predetermined fixed period from a current point in time into the past (for example, the same period as the bank busy time) is configured.

Also, according to the first embodiment, the memory access control device 200 in which the request acceptance history acquisition section 231 is configured to set a period for storing the request acceptance history information REQHIS (for example, the same period as the bank busy time) on the basis of the bank busy time is configured.

Also, according to the first embodiment, there is provided an image processing device (the image processing device 20), including: a memory access control device (the memory access control device 200) which includes a plurality of bus masters (bus masters 220) configured to output an access request (a DMA request) to a memory (the DRAM 30) in which an address space is divided into a plurality of banks; an arbiter (the DMA bus arbitration section 230) connected to the DRAM 30 and configured to arbitrate the DMA request output from each of the bus masters 220 and control access to the DRAM 30 in response to the DMA request which has been accepted; and a request acceptance history acquisition section (the request acceptance history acquisition section 231) configured to acquire information about a plurality of DMA requests accepted by the DMA bus arbitration section 230 (request acceptance history information), store the acquired information as the request, acceptance history information (request acceptance history information REQHIS), and output the stored request acceptance history information REQHIS, wherein, when at least one bus master 220 with a high priority among the plurality of bus masters 220 is defined as a high-priority bus master (for example, the bus master 220-1), the bus master 220-1 is configured to determine an order of banks specified according to each DMA request (more specifically, an order of bank addresses BA) with reference to the request acceptance history information REQHIS when the plurality of banks of the DRAM 30 are successively accessed and is configured to output the DMA request for specifying the banks in the determined order.

Also, according to the first embodiment, there is provided an imaging device (the imaging device 1), including: an image processing device (the image processing device 20) which includes a memory access control device (the memory access control device 200) including a plurality of bus masters (bus masters 220 configured to output an access request (a DMA request) to a memory (the DRAM 30) in which an address space is divided into a plurality of banks; an arbiter (the DMA bus arbitration section 230) connected to the DRAM 30 and configured to arbitrate the DMA request output from each of the bus masters 220 and control access to the DRAM 30 in response to the DMA request which has been accepted; and a request acceptance history acquisition section (the request acceptance history acquisition section 231) configured to acquire information about a plurality of DMA requests accepted by the DMA bus arbitration section 230 (request acceptance history information), store the acquired information as the request acceptance history information (request acceptance history information REQHIS), and output the stored request acceptance history information REQHIS, wherein, when at least one bus master 220 with a high priority among the plurality of bus masters 220 is defined as a high-priority bus master (for example, the bus master 220-1), the bus master 220-1 is configured to determine an order of banks specified according to each DMA request (more specifically, an order of bank addresses BA) with reference to the request acceptance history information REQHIS when the plurality of banks of the DRAM 30 are successively accessed and is configured to output the DMA request for specifying the banks in the determined order.

As described above, the memory access control device according to the first embodiment of the present invention stores a history of DMA transfers of the bus masters 220 sharing the DRAM 30, i.e., the request acceptance history information which is a history of accesses to the DRAM 30. In the memory access control device according to the first embodiment of the present invention, each bus master 220 changes an order of bank addresses BA to be accessed in the DRAM 30, i.e., an order of DMA transfers, so that access to a bank in the bank busy state is avoided with reference to the stored request acceptance history information immediately before the DMA transfer starts. Thereby, in the memory access control device according to the first embodiment of the present invention, it is possible to successively perform the DMA transfers in an order in which the constraints of the bank busy time in the DRAM 30 are avoided. Thereby, in the memory access control device according to the first embodiment of the present invention, the efficiency of access to the DRAM 30 can be improved when a DMA transfer from and to the DRAM 30 is performed.

Also, in the first embodiment of the present invention, a case in which the bus master 220-1, which is a high-priority bus master provided in the memory access control device 200, performs a DMA transfer by successively accessing a plurality of banks provided in the DRAM 30 in one successive transfer has been described. In the first embodiment of the present invention, a case in which the DMA bas arbitration section 230, which is the arbiter provided in the memory access control device 200, does not accept the DMA request from the bus master 220-2 even when the bus master 220-2, which is a low-priority bus master provided in the memory access control device 200, outputs a new DMA request during a period in which the bus master 220-1 outputs the DMA request in one successive transfer, i.e., dining a period of eight DMA transfers, has been described. However, a case in which, during a period in which the bus master 220-1 outputs a series of DMA requests, the DMA request output by another low-priority bus master provided in the memory access control device 200 is accepted by the DMA bus arbitration section 230 may also be conceived. In this case, the DMA transfer of the bus master 220-1 is on standby until the DMA transfer of the other low-priority bus master accepting the DMA request is completed. Thus, in the memory access control device of the present invention, a function of preventing the DMA request from another low-priority bus master from being accepted during a period in which the high-priority bus master outputs a series of DMA requests may be provided. According to this function, the memory access control device of the present invention can more reliably obtain the effect of shortening the period until the series of DMA transfers in the high-prior bus master is completed.

Also, in the first embodiment, a case in which the bus master 220-1, which is the high-priority bus master provided in the memory access control device 200, determines an order of bank addresses BA for accessing the DRAM 30 with reference to the request acceptance history information REQHIS immediately before one successive transfer starts has been described. However, a case in which another low-priority bus master including the bus master 220-2 provided in the memory access control device 200 newly outputs a DMA request while the bus master 220-1 is performing the address order determination process of determining the older of bank addresses BA may also be conceived. A case in which the bank of the DRAM 30 specified by another low-priority bus master provided in the memory access control device 200 is the same as a first bank determined by the bus master 220-1 in the address order determining process may also be conceived. In this case, a first DMA transfer in one successive transfer of the bus master 220-1 is on standby until the bank busy time of the bank specified by the other low-priority bus master elapses. Thus, the memory access control device of the present invention may have a function of preventing a DMA request from another low-priority bus master from being accepted while the high-priority bus master is performing the address order determination process. According to this function, the memory access control device of the present invention can more reliably obtain the effect of changing the order of bank addresses BA, i.e., the effect of improving the efficiency of access to the DRAM 30 and shortening a period until a series of DMA transfers are completed.

### Second Embodiment

Next, a memory access control device according to a second embodiment of the present invention will be described. The memory access control device according to the second embodiment of the present invention is a memory access control device configured to have a function of preventing a DMA request from another low-priority bus master from being accepted during a period in which a high-priority bus master outputs a series of DMA requests and while the high-priority bus master is performing an address order determination process.

Also, in the following description, for example, a case in which the memory access control device according to the second embodiment of the present invention is provided in an image processing device mounted on an imaging device such as a still-image camera or a moving-image camera will be described. The configuration of the imaging device equipped with the image processing device having the memory access control device according to the second embodiment of the present invention is similar to a schematic configuration of the imaging device 1 equipped with the image processing device 20 having the memory access control device according to the first embodiment shown in FIG. 1. Accordingly, detailed description of the configuration of the imaging device equipped with the image processing device having the memory access control device according to the second embodiment of the present invention will be omitted and the same reference signs are used for description when components similar to those of the imaging device 1 equipped with the image processing device 20 having the memory access control device according to the first embodiment shown in FIG. 1 are represented.

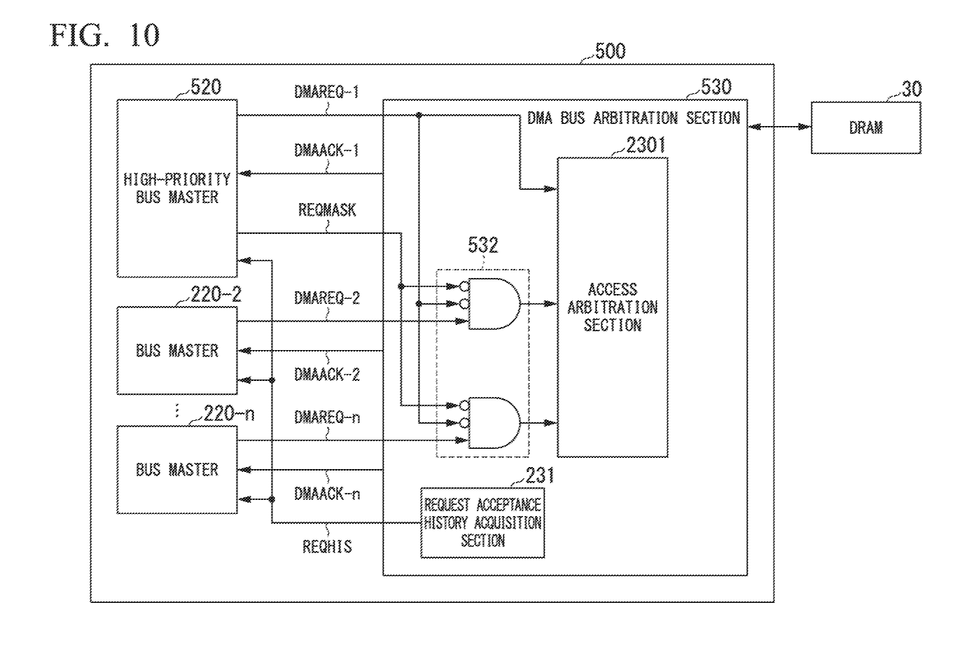

Next, a configuration and an operation of the memory access control device according, to the second embodiment of the present invention will be described. FIG. 10 is a block diagram showing a schematic configuration of a memory access control device according to the second embodiment of the present invention. In the following description, the memory access control device according to the second embodiment of the present invention will be referred to as a “memory access control device 500”. In FIG. 10, as in the memory access control device 200 of the first embodiment shown in FIG. 2, an example of a schematic configuration of the memory access control device 500 including n (n is a natural number or a positive integer) bus masters and an arbiter and configured to access the DRAM 30 according to a DMA transfer is shown.

However, in the memory access control device 500 shown in FIG. 10, one bus master is a high-priority bus master. In the memory access control device 500, a function of preventing a DMA request from another low-priority bus master from being accepted during a period in which the high-priority bus master outputs a series of DMA requests and while an address order determination process for determining an order of bank addresses BA to be specified when the DMA transfer is performed is provided. The memory access control device 500 shown in FIG. 10 includes a high-priority bus master 520, n-1 (n is a natural number or a positive integer) bus masters 770-2 to 220-n, a DMA bus arbitration section 530.

The components constituting the memory access control device 500 shown in FIG. 10 include components similar to as those constituting the memory access control device 200 according to the first embodiment shown in FIG. 2. Accordingly, in the following description, the components constituting the memory access control device 500 similar to those constituting the memory access control device 200 of the first embodiment are denoted by the same reference signs and detailed description thereof will be omitted. Also in the following description, the bus masters 220-2 to 220-n are referred to as “bus masters 220” unless they are represented without distinction. Also, in the imaging device 1 shown in. FIG. 1, the high-priority bus master 520 corresponds to, for example, the imaging interface section 221 or the display interface section 224 provided in the image processing device 20, and each of the bus masters 220 corresponds to any other processing block provided in the image processing device 20.

In the memory access control device 500 shown in FIG. 10, the high-priority bus master 520 is provided in place of the bus master 220-1 provided in the memory access control device 200 of the first embodiment shown in FIG. 2. Also, in the memory access control device 500 shown in FIG. 10, the DMA bus arbitration section 530 is provided in place of the DMA bus arbitration section 230 provided in the memory access control device 200 of the first embodiment shown in FIG. 2. The DMA bus arbitration section 530 includes an access arbitration section 2301, a request acceptance history acquisition section 231, and a request acceptance mask section 532. Also, the configuration of the DMA bus arbitration section 530 is a configuration in which the request acceptance mask section 532 is added to the DMA bus arbitration section 230 constituting the memory access control device 200 of the first embodiment shown in FIG. 3. That is, in FIG. 10, the illustration of components of the memory control section 2302, the multiplexer (MUX) 2303, the address generation section 2304, and the data control section 2305 which are provided in both the DMA bus arbitration section 530 and the DMA bus arbitration section 230 is omitted.

Similar to each bus master 220, the high-priority bus master 520 outputs a DMA request signal DMAREQ-1 indicating that a DMA transfer is requested for the DRAM 30, a DMA address DMAAD-1 indicating an address of the DRAM 30 to be accessed, and a DMA reading/writing signal DMARW-1 for specifying a direction of access to the DRAM 30 to the DMA bus arbitration section 530 when the DMA transfer starts. Also, similar to each bus master 220, the high-priority bus master 520 starts a requested DMA transfer after a notification of DMA permission is provided according to the DMA permission signal DMAACK-1 output from the DMA bus arbitration section 530. Also, in FIG. 10, only signals of the DMA request signal DMAREQ-1 and the DMA permission signal DMAACK-1 exchanged between the high-priority bus master 520 and the DMA bus arbitration section 530 are shown.

Also, when the DMA transfer for the DRAM 30 is requested, the high-priority bus master 520 outputs a request acceptance mask signal REQMASK for issuing an instruction for masking the DMA request output from the bus master 220 provided in the memory access control device 500 to the DMA bus arbitration section 530. The request acceptance mask signal REQMASK is a signal for masking the DMA request signal DMAREQ output from the bus master 220 so that the DMA bus arbitration section 530 prevents the DMA request signal DMAREQ from being accepted during a period of the address order determination process in which the high-priority bus master 520 determines an order of bank addresses BA with reference to the request acceptance history information REQHIS.

Similar to the DMA bus arbitration section 230 constituting the memory access control device 200 of the first embodiment, the DMA bus arbitration section 530 arbitrates DMA request signals DMAREQ output from the high-priority bus master 520 and the bus master 220 through the access arbitration section 2301 and outputs a DMA permission signal DMAACK for notifying that the DMA request has been accepted to the high-priority bus master 520 or the bus master 220 accepting the DMA request.

Also, in the DMA bus arbitration section 530, the request acceptance mask section 532 masks the output of the DMA request signal DMAREQ output from each bus master 220 to the access arbitration section 2301 in accordance with the DMA request signal DMAREQ-1 and the request acceptance mask signal REQMASK output from the high-priority bus master 520. Thereby, the access arbitration section 2301 provided in the DMA bus arbitration section 530 accepts the DMA request signal DMAREQ-1 output from the high-priority bus master 520 without arbitrating the DMA request from the bus master 220 in a state in which the DMA request signal DMAREQ is masked.

Similar to the DMA bus arbitration section 230, the DMA bus arbitration section 530 actually controls the DRAM 30 in accordance with access from either the high-priority bus master 520 or the bus master 220 accepting the DMA request to the DRAM 30 and performs a transfer of data between the bus master 220 accepting the DMA request and the DRAM 30 (a DMA transfer).

Also, similar to the DMA bus arbitration section 230 constituting the memory access control device 200 of the first embodiment, the DMA bus arbitration section 530 acquires and stores request acceptance history information related to the accepted DMA requests through the request acceptance history acquisition section 231 and outputs the stored request acceptance history information REQHIS to each of the high priority bus master 520 and the bus master 220.

Next, a more detailed configuration and operation of the high-priority bus master 520 constituting the memory access control device 500 will be described. In the following description, the high-prior bus master 520 in which a direction of access to the DRAM 30 in the DMA transfer is only writing access (data writing) will be described as an example. The high-priority bus master 520 configured to perform the DMA transfer only for the writing access corresponds to, for example, the imaging interface section 221 in the imaging device 1 shown in FIG. 1.

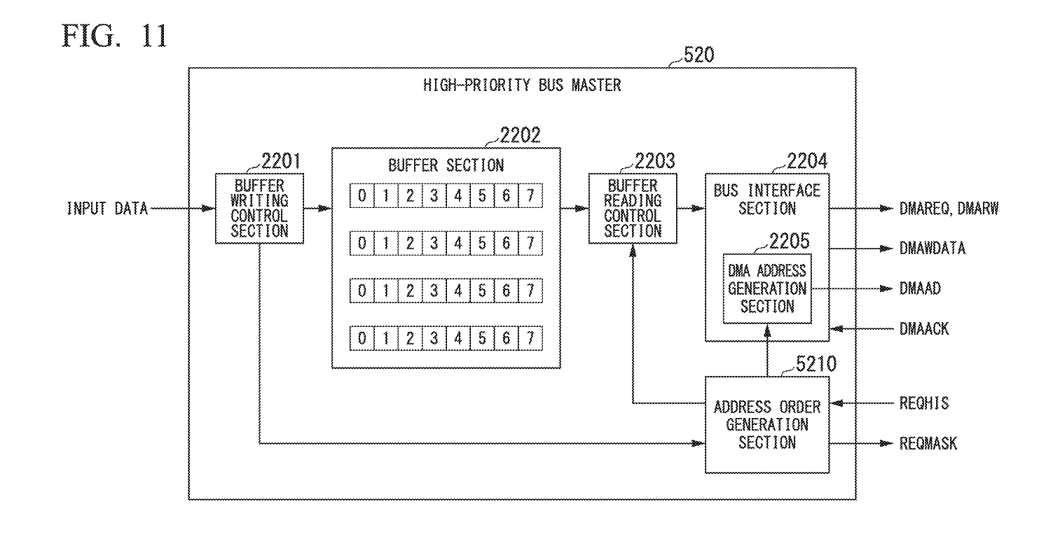

FIG. 11 is a block diagram showing a schematic configuration of the high-priority bus master 520 constituting the memory access control of device 500 according to the second embodiment of the present invention. An example of a configuration of the high-priority bus master 520 which performs eight successive DMA transfers with respect to eight banks provided in the DRAM 30 in one successive transfer as in the bus master 220 shown in FIG. 5 is shown. The high-priority bus master 520 includes a buffer writing control section 2201, a buffer section 2202, a buffer reading control section 2203, a bus interface section 2204, and an address order generation section 5210. Also, the bus interface section 2204 includes a DMA address generation section 2205.

The high-priority bus master 520 is different from the bus master 220 shown in FIG. 5 only in that a function of outputting the request acceptance mask signal REQMASK is provided. Thus, components of the high-priority bus master 520 shown in FIG. 11 include components similar to those included in the bus master 220 shown in FIG. 5. Accordingly, in the following description, the components of the high-priority bus master 520 similar to those of the bus master 220 are denoted by the same reference signs and detailed description thereof will be omitted and only differences from the bus master 220 will be described.

Similar to the address order generation section 2210 provided in the bus master 220 shown in FIG. 5, the address order generation section 5210 determines an order of bank addresses BA for specifying banks provided in the DRAM 30 to be specified when the DMA writing data DMAWDATA (input data) is transferred according to eight successive DMA transfers with reference to the request acceptance history information REQHIS output from the DMA bus arbitration section 530 when input data is stored (saved) in any set of storage regions within the buffer section 2202 by the buffer writing control section 2201.

Also, because the address order determination process in which the address order generation section 5210 determines an order of addresses with reference to the request acceptance history information REQHIS is similar to the address order determination process in which the address order generation section 2210 shown in FIGS. 6, 8, and 9 determines an order of addresses with reference to the request acceptance history information REQHIS, a detailed description thereof will be omitted.

Also, when the high-priority bus master 520 (more specifically, the bus interface section 2204) requests a DMA transfer with respect to the DRAM 30, the address order generation section 5210 generates a request acceptance mask signal REQMASK for issuing an instruction for masking the DMA request signal DMAREQ output from each of the bus masters 220 provided in the memory access control device 500. The request acceptance mask signal REQMASK is a signal for issuing an instruction for masking the DMA request from another bus master 220 provided in the memory access control device 500 until the bus interface section 2204 outputs the DMA request signal DMAREQ from when the address order generation section 5210 starts the address order determination process of determining an order of bank addresses BA (or a cycle a while ago) with reference to the request acceptance history information REQHIS.

Then, the address order generation section 5210 outputs the generated request acceptance mask signal REQMASK to the DMA bus arbitration section 530. In accordance with this request acceptance mask signal REQMASK, the request acceptance mask section 532 provided in the DMA bus arbitration section 530 masks an output of a DMA request signal DMAREQ other than the DMA request signal DMAREQ-1 output from the high-priority bus master 520 to the access arbitration section 2301 as described above.

Also, the address order generation section 5210 may start the output of the request acceptance mask signal REQMASK from any timing before the buffer writing control section 2201 starts the reading of input data of one transfer unit stored (saved) by the buffer reading control section 2203 from the buffer section 2202 after the storage (saving) of the input data of one transfer unit in the buffer section 2202 is completed.

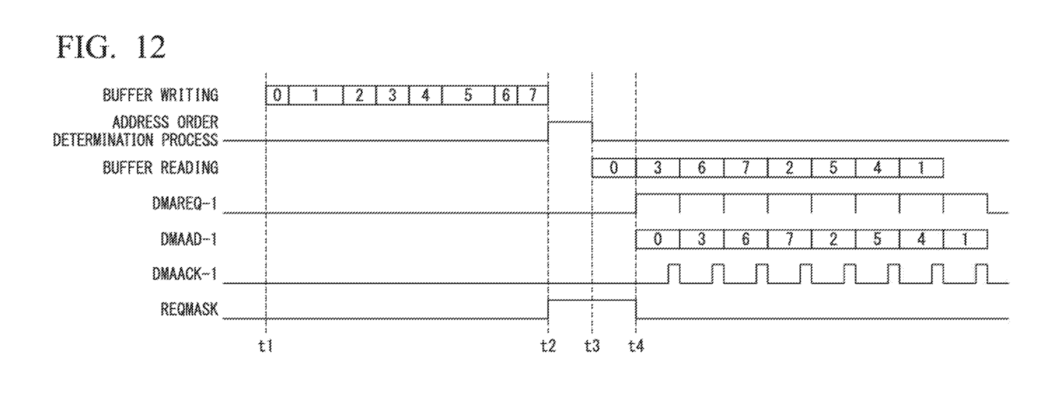

Here, the operation of the high-priority bus master 520 will be described. FIG. 12 is a timing chart showing an example of the operation timing of the high-priority bus master 520 constituting the memory access control device 500 according to the second embodiment of the present invention. In the timing chart shown in FIG. 12, the operation in which the address order generation section 5210 generates the request acceptance mask signal REQMASK will be described.

From a timing t1, the buffer writing control section 2201 provided in the high-priority bus master 520 sequentially outputs input data which has been input (for example, pixel signal data output from the image sensor 10) to the buffer section 2202 and causes the buffer section 2202 to store (save) the data. Thereafter, the buffer writing control section 2201 notifies the address order generation section 5210 and the buffer reading control section 2203 that the storage (saving) of the input data for the buffer section 2202 has been completed at a timing at which the storage (saving) of the input data of one transfer unit in the buffer section 2202 has been completed. Also, a method of notifying that the buffer writing control section 2201 has completed the storage (saving) of input data of one transfer unit in the buffer section 2202 in the high-priority bus master 520 is not limited at all.

When the notification indicating that the storage (saving) of input data of one transfer unit to the buffer section 2202 has been completed is provided from the buffer writing control section 2201, the address order generation section 5210 starts an address order determination process with reference to the request acceptance history information REQHIS from a timing t2. Also, in the timing chart shown in FIG. 12, the address order generation section 5210 indicates a period of the address order determination process by a “High” level. The address order generation section 5210 outputs the request acceptance mask signal REQMASK indicating that the DMA request from another bus master 220 provided in the memory access control device 500 is masked (the “High” level in FIG. 12) to the DMA bus arbitration section 530 at the timing t2 at which the address order determination process starts with reference to the request acceptance history information REQHIS. Thereby, the request acceptance mask section 532 provided in the DMA bus arbitration section 530 masks the DMA request signal DMAREQ output from the bus master 220 other than the high-priority bus master 520 provided in the memory access control device 500 in accordance with the request acceptance mask signal REQMASK output from the address order generation section 5210 provided in the high-priority bus master 520.

Thereafter, when the address order determination process is completed at a timing t3, the address order generation section 5210 outputs address order information indicating the determined order of addresses (more specifically, bank addresses BA) to each of the buffer reading control section 2203 and the DMA address generation section 2205 within the bus interface section 2204. Thereby, the buffer reading control section 2203 sequentially reads all input data of the transfer unit of one successive transfer stored (saved) in the buffer section 2202, i.e., input data of eight DMA transfers, in an order indicated by the address order information and transfers the input data to the bus interface section 2204.

When input data of the transfer unit of a first DMA transfer is transferred from the buffer reading control section 2203, the bus interface section generates each of a DMA request signal DMAREQ-1 for requesting the DMA transfer of the input data, a DMA reading/writing signal DMARW-1 indicating writing access, and a DMA address DMAAD for specifying a bank address BA shown in the address order information. Then, at a timing t4 the bus interface section 2204 outputs the DMA request signal DMAREQ-1, the DMA reading/writing signal DMARW-1 (not shown), and the DMA address DMAAD-1 which have been generated to the DMA bus arbitration section 530. At this time, the bus interface section 2204 notifies the address order generation section 5210 that the DMA request signal DMAREQ-1 has been output. Also, a method of notifying that the bus interface section 2204 has output the DMA request signal DMAREQ-1 in the high-priority bus master 520 is not limited at all.

In accordance with the notification indicating that the DMA request signal DMAREQ-1 input from the bus interface section 2204 has been output, the address order generation section 5210 sets the request acceptance mask signal REQMASK to be output to the DMA bus arbitration section 530 in a state indicating that the DMA request from the other bus master 220 provided in the memory access, control device 500 is not masked (the “Low” level in FIG. 12). Thereby, the request acceptance mask section 532 provided in the DMA bus arbitration section 530 releases the mask of the DMA request signal DMAREQ output from the bus master 220 other than the high-priority bus master 520 provided in the memory access control device 500 in accordance with the request acceptance mask signal REQMASK output from the address order generation section 5210 provided in the high-priority bus master 520.

At such a timing, the address order generation section 5210 outputs the request acceptance mask signal REQMASK to the DMA bus arbitration section 530 until the timing t4 at which the bus interface section 2204 outputs the DMA request signal DMAREQ from the timing t2 at which the address order determination process starts with reference to the request acceptance history information REQHIS. Thereby, the DMA bus arbitration section 530 accepts only the DMA request output from the high-priority bus master 520 and outputs the DMA permission signal DMAACK-1 to the high-priority bus master 520. Thereafter, the DMA bus arbitration section 530 performs eight successive DMA transfers (one successive transfer) in accordance with each DMA request signal DMAREQ-1 output from the high-priority bus master 520.

In this manner, in the memory access control device 500, the high-priority bus master 520 instructs the DMA bus arbitration section 530 not to accept the DMA request signal DMAREQ output from another bus master 220 during a period of an address order determination process of determine an order of bank addresses BA with reference to the request acceptance history information REQHIS by outputting the request acceptance mask signal REQMASK. Thereby, when the high-priority bus master 520 performs the DMA transfer from and to the DRAM 30, the memory access control device 500 can more reliably obtain an effect of improving the efficiency of access to the DRAM 30 and shortening a period until a series of DMA transfers is completed.

According to the second embodiment, the memory access control device (the memory access control device 500) in which the high-priority bus master (the high-priority bus master 520) is configured to output a request acceptance mask signal (the request acceptance mask signal REQMASK) for issuing an instruction for masking acceptance of the access request (the DMA request) input from another bus master (the bus master 220) during a period until the DMA request (the DMA request signal DMAREQ) is first output from when a process (an address order determination process) of determining the order of banks (more specially, the order of bank addresses BA) specified according to each DMA request starts (or a cycle a while ago) and the arbiter (the DMA bus arbitration section 230) is configured to mask the DMA request input from the bus master 220 other than the high-priority bus master 520 in accordance with the request acceptance mask signal REQMASK is configured.

Also, according to the second embodiment, the memory access control device 500 in which the DMA bus arbitration section 230 is further configured to mask the DMA request input from another bus master 220 during the period in which each DMA request is output from the high-priority bus master 520 is configured.

As described above, also in the memory access control device according to the second embodiment of the present invention, as in the memory access control device of the first embodiment, stores a history of access to the DRAM 30 (request acceptance history information) each of the high-priority bus master 520 and the bus masters 220 sharing the DRAM 30 and the order of DMA transfers is changed to avoid access to a bank in the bank busy state. Thereby, in the memory access control device according to the second embodiment of the present invention, as in the memory access control device of the first embodiment, it is also possible to improve the efficiency of access to the DRAM 30 by successively performing DMA transfers in an order for avoiding the constraint of the bank busy time in the DRAM 30.

Also, in the memory access control device according to the second embodiment of the present invention, the high-priority bus master 520 instructs the DMA bus arbitration section 530 to mask a DMA request so that the DMA request output from another bus master 220 is not accepted during the address order determination process of determining an order of bank addresses BA with reference the request acceptance history information. Thereby, in the memory access control device 500, the high-priority bus master 520 can more reliably obtain the effect of improving the efficiency of access to the DRAM 30 and the effect of shortening the period until a series of DMA transfers is completed.

Also, although it is possible to implement a configuration having a function of masking a DMA request output from a low-priority bus master even in the conventional memory control device, the memory access control device according to the second embodiment of the present invention accesses the DRAM 30 in the order of bank addresses BA for avoiding access to a bank in the bank busy state determined in the address order determination process. Thus, the memory access control device according to the second embodiment of the present invention can avoid more bank collisions than in the conventional memory control device having the function of masking a DMA request output from a low-priority bus master.

As described above, according to the embodiments of the present invention, the arbiter (the DMA bus arbitration section) constituting the memory access control device of the present invention stores a history in which bus masters (processing blocks) constituting the memory access control device of the present invention have accessed the shared DRAM in the DMA transfer (request acceptance history information). In the embodiments of the present invention, a high-priority bus master among the bus masters constituting the memory access control device of the present invention determines an order for performing the DMA transfer and outputs the DMA request in the determined order so that the DRAM is accessed in a state in which the efficiency of access is high with reference to the request acceptance history information immediately before the DMA request is output to the arbiter constituting the memory access control device of the present invention. More specifically in each embodiment of the present invention, the high-priority bus master constituting the memory access control device of the present invention determines an order for accessing each bank provided in the DRAM in the DMA transfer (an order of bank addresses) so that access to a bank in the bank busy state is avoided and outputs the DMA request for performing the DMA transfer from and to the DRAM in the determined order of bank addresses. Thereby, in each embodiment of the present invention, the arbiter constituting the memory access control device of the present invention can improve efficiency when the DRAM is accessed and secure a bandwidth of the DMA transfer in the high-priority bus master constituting the memory access control device of the present invention. Thereby, in each embodiment of the present invention, it is possible to secure performance in the image processing device including the memory access control device of the present invention. In each embodiment of the present invention, it is possible to implement a function in the imaging device equipped with an image processing device including the memory access control device of the present invention.

Also, in each embodiment of the present invention, a case in which all bus masters constituting the memory access control device of the present invention have a function of determining an order for performing a DMA transfer with reference to the request acceptance history information has been described. This is because the high-priority bus master differs according to an operation mode in the imaging device equipped with the image processing device including the memory access control device of the present invention. However, for example, if there is a low-priority bus master at all times regardless of the operation mode, the low-priority bus master may be configured without a function of determining an order for performing DMA transfers with reference to the request acceptance history information.

Also, in each embodiment of the present invention, a case in which the number of high-priority bus masters among the bus masters constituting the memory access control device of the present invention is one has been described. However, a plurality of high-priority bus masters may be provided in the memory access control device. In this case, in the memory access control device of the present invention, a configuration in which high-priority bus masters mutually know information of an order of bank addresses BA which is not included in the request acceptance history information such as a configuration in which high-priority bus masters share information of a determined order for performing the DMA transfer may be provided. By providing this configuration, it is possible to prevent an order of bank addresses BA when the DMA transfer is performed determined by a high-priority bus master for subsequently performing the DMA transfer from being set in ascending order of efficiency of access according to an order of bank addresses BA when a DMA transfer determined by a high-priority bus master for first performing the DMA transfer is performed. Also, a configuration in which a high-priority bus master of which the DMA request has not been accepted re-determines an order for performing the DMA transfer with reference to the request acceptance history information by notifying that the DMA request of another high-priority bus master has been accepted may be adopted.

Also, in the second embodiment of the present invention, a configuration in which the request acceptance mask section 532 provided in the arbiter (the DMA bus arbitration section 530) constituting the memory access control device of the present invention masks a DMA request from another bus master also during a period in which a high-priority bus master (the high-priority bus master 520) constituting the memory access control device of the present invention outputs a series of DMA requests is shown. More specifically, a configuration in which the request acceptance mask section 532 masks the DMA request signal DMAREQ output from the other bus master 220 also in accordance with the DMA request signal DMAREQ-1 output by the high-priority bus master 520 in addition to the request acceptance mask signal REQMASK is shown. However, for example, if there is one high-priority bus master 520, the DMA bus arbitration section 530 can preferentially accept a series of DMA requests output by the high-priority bus master 520 in a normal arbitration process. Also, for example, even when there are a plurality of high-priority bus masters 520, it is possible to arbitrate the DMA request output from each high-priority bus master 520 by adopting a configuration in which a function of determining a period during which a series of DMA requests is output is provided in the DMA bus arbitration section 530. In such a case, the request acceptance mask section 532 may be configured to mask the DMA request from another bus master only during a period in which the high-priority bus master 520 performs a process of determining an order for performing DMA transfers (an address order determination process) with reference to the request acceptance history information.

Also, in each embodiment of the present invention, a case in which information such as the bank address information, the information indicating the access direction, and the information indicating a timing at which the DMA request has been accepted is stored as the request acceptance history information has been described. However, information to be stored as the request acceptance history information is not limited to the information shown in each embodiment of the present invention. For example, if an amount of data to be transferred from and to the DRAM in the DMA transfer is output together with the DMA request from the bus master, information indicating the amount of data may also be stored in association with information serving as the request acceptance history information. In this case, even when the bus master outputs a DMA request for accessing a plurality of successive bank addresses in one DMA transfer, it is possible to recognize each of a plurality of banks accessed by the bus master on the basis of information of a bank address and an amount of data included in the request acceptance history information.

Also, in each embodiment of the present invention, a configuration in which the request acceptance history acquisition section 231 for storing the request acceptance history information and the request acceptance mask section 532 for masking the DMA request signal DMAREQ are provided in an arbiter constituting the memory access control device of the present invention (the DMA bus arbitration section 230 or the DMA bus arbitration section 530) is shown. However, in the present invention, a configuration including the request acceptance history acquisition section 231 or the request acceptance mask section 532 (i.e., a position at which the request acceptance history acquisition section 231 or the request acceptance mask section 532 are disposed) is not limited to the configurations of the embodiments of the present invention, and there may be a configuration in which these are provided outside the arbiter. For example, if some or all of the functions of the memory access control device of the present invention are implemented by an integrated circuit such as a dedicated large scale integration (LSI), i.e., a so-called application specific integrated circuit (ASIC), general-purpose intellectual property (IP) cores and IP modules already available on the market may be used as the arbiter. In this case, it may be difficult to add the request acceptance history acquisition section 231 or the request acceptance mask section 532 by changing the general-purpose IP core or IP module. Inherently, information about the internal configuration of a general-purpose IP core or IP module may not be disclosed. Thus, the request acceptance history acquisition section 231 or the request acceptance mask section 532 is disposed outside the arbiter. Even in this case, it is possible to obtain an effect similar to that of each embodiment of the present invention. If the request acceptance history acquisition section 231 is configured to be provided outside the arbiter, the request acceptance history storage section 2312 provided in the request acceptance history acquisition section 231 is configured to store the request acceptance history information corresponding to the DMA permission signal DMAACK at a timing at which any DMA permission signal DMAACK is output from the arbiter. More specifically, at a timing when any DMA permission signal DMAACK has been output from the arbiter, information such as information of the bank address BA indicated by the DMA address DMAAD corresponding to the DMA permission signal DMAACK, information indicating the access direction indicated by the DMA reading/writing signal DMARW, and a time T output from the counter section 2311 is configured to be stored in association as request acceptance history information.

Also, in each embodiment of the present invention, a configuration in which the memory access control device of the present invention is provided in the image processing device mounted on the imaging device has been described. However, in addition to the image processing device and the imaging device described in each embodiment of the present invention, various systems are conceivable as a system having a memory access control device configured to perform a DMA transfer. Accordingly, the processing device and the system to which the memory access control device based on the concept of the present invention can be applied are not limited at all. That is, a concept of the memory access control device of the present invention can be similarly applied to any processing device or any system for performing a DMA transfer. It is then possible to obtain an effect similar to that of the memory access control device of the present invention.

While preferred embodiments of the present invention have been described and shown above, the present invention is not limited to the embodiments and modified examples thereof. Within a range not departing from the gist or spirit of the present invention, additions, omissions, substitutions, and other modifications to the configuration can be made.

Also, the present invention is not to be considered as being limited by the foregoing description, and is limited only by the scope of the appended claims.

What is claimed is:

1. A memory access control device, comprising:
a plurality of bus masters configured to output an access request to a memory in which an address space is divided into a plurality of banks;
an arbiter connected to the memory and configured to arbitrate the access request output from each of the bus masters and control access to the memory in response to the access request which has been accepted; and
a request acceptance history acquisition section configured to acquire information about a plurality of access requests accepted by the arbiter, store the acquired information as request acceptance history information, and output the stored request acceptance history information,
wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and output the access request for specifying the banks in the determined order.

2. The memory access control device according to claim 1,
wherein the request acceptance history acquisition section is configured to store the request acceptance history information including information of the banks specified in the access request and information indicating a direction of access to the memory are associated for each access request accepted by the arbiter, and
wherein the high-priority bus master is configured to determine the order of banks specified according to each access request on the basis of the information of the banks included in the request acceptance history information and avoiding access to the same bank within a predetermined time.

3. The memory access control device according to claim 2,
wherein the request acceptance history acquisition section is further configured to acquire information indicating a timing at which the access request has been accepted by the arbiter, and the request acceptance history information is including the acquired information indicating the timing.

4. The memory access control device according to claim 3,
wherein the request acceptance history acquisition section is configured to store a predetermined number of pieces of the request acceptance history information going back from the access request most recently accepted by the arbiter or the request acceptance history information for a predetermined fixed period from a current point in time into the past.

5. The memory access control device according to claim 4,
wherein the request acceptance history acquisition section is configured to set a period for storing the request acceptance history information on the basis of the predetermined time.

6. The memory access control device according to claim 1,
wherein the high-priority bus master is configured to output request acceptance mask signal for issuing an instruction for masking acceptance of the access request input from another bus master during a period until the access request is first output from when a process of determining the order of banks specified according to each access request starts, and
wherein the arbiter is configured to mask the access request input from a bus master other than the high-priority bus master in accordance with the request acceptance mask signal.

7. The memory access control device according to claim 6,
wherein the arbiter is further configured to mask the access request input from another bus master during a period in which each access request is output from the high-priority bus master.

8. An image processing device, comprising:
a memory access control device which includes
a plurality of bus masters configured to output an access request to a memory in which an address space is divided into a plurality of banks;
an arbiter connected to the memory and configured to arbitrate the access request output from each of the bus masters and control access to the memory in response to the access request which has been accepted; and
a request acceptance history acquisition section configured to acquire information about a plurality of access requests accepted by the arbiter, store the acquired information as request acceptance history information, and output the stored request acceptance history information,
wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and is configured to output the access request for specifying the banks in the determined order.

9. An imaging device, comprising:
an image processing device which includes
a memory access control device including
a plurality of bus masters configured to output an access request to a memory in which an address space is divided into a plurality of banks;
an arbiter connected to the memory and configured to arbitrate the access request output from each of the bus masters and control access to the memory in response to the access request which has been accepted; and
a request acceptance history acquisition section configured to acquire information about a plurality of access requests accepted by the arbiter, store the acquired information as request acceptance history information, and output the stored request acceptance history information,
wherein, when at least one bus master with a high priority among the plurality of bus masters is defined as a high-priority bus master, the high-priority bus master is configured to determine an order of banks specified according to each access request with reference to the request acceptance history information when the plurality of banks of the memory are successively accessed and is configured to output the access request for specifying the banks in the determined order.
